(19) United States
(12) Patent Application Publication
(10) Pub. No.: US 2006/0212407 A1
(43) Pub. Date: Sep. 21, 2006

(54) User authentication and secure transaction system

(76) Inventor: Dennis Bower Lyon, Oceanside, CA (US)

Correspondence Address: RICK MARTIN;PATENT LAW OFFICES OF RICK MARTIN, PC, 416 COFFMAN STREET, LONGMONT, CO, 80501, US

(21) Appl. No.: 11/158,731

(22) Filed: Jun. 22, 2005

Related U.S. Application Data
(60) Provisional application No. 60/662,566, filed on Mar. 17, 2005.

(51) Int. Cl. G06Q 99/00

(52) U.S. Cl. 705/71

(57) ABSTRACT

A system, method, and apparatus to minimize fraud at the user, merchant, and/or financial institution level. A control computer provides authentication and/or transaction processing. The control computer has access to databases comprising user, merchant, enrollment, transaction, duplicate, and fraudulent activity data. Parties may enroll in the system via an enrollment computer and conduct transactions through the system via a merchant computer. Users are issued hardware identification keys containing an encrypted user code. Access keys can be required in addition to an authorized user key to conduct certain actions. Keys are copy protected and can comprise a computer operating system. The hardware profile of client devices can be recorded. Parties may specify minimum and/or maximum security levels and restrict transactions. Transactions with parties can be authenticated without sending user personal data to the parties. Users can control transfer of information from their personal communication device to other devices.

### CROSS REFERENCE APPLICATIONS

This application is a non-provisional application claiming the benefits of provisional application No. 60/662,566 filed Mar. 17, 2005.

### BACKGROUND

A problem exists in ensuring that only authorized persons are allowed access to secure areas, secure networks, and secure transactions. For example, it may be necessary to verify the identity of a person seeking entry into a building prior to allowing such entry to be sure that the person is authorized to gain such entry. Similarly, it may be necessary to verify the identity of a person seeking access to a secure network of computers prior to allowing such access to be sure that the person is authorized to gain such access. Further, it may be necessary to verify the identity of a person seeking to complete a financial transaction over a computer network, such as the Internet, or by means of a credit or debit card at a retail location, prior to entering into the transaction to prevent fraud. In the latter case, the problem of identity theft in economic transactions is a rampant problem that continues despite substantial efforts to prevent it.

### SUMMARY

The following embodiments and aspects thereof are described and illustrated in conjunction with systems, tools and methods which are meant to exemplify and illustrate, and not be limiting in scope. In various embodiments, one or more of the above-described problems have been reduced or eliminated, while other embodiments are directed to other improvements.

A multi computer distributed data processing system (DDPS), with hierarchical keys which limit damage caused by fraudulent activity at any level of authority, is disclosed. A party may be identified by an access or user key comprising information identifying the party. Each key has limited data to necessitate interactive authentication with a central control computer, thereby minimizing damages by theft and/or copying of the key itself.

An access key can be required in addition to an authorized user key to conduct certain actions. A key may comprise a computer operating system. A device connected to the DDPS may be authenticated through its hardware and/or software characteristics. The DDPS can control access to the device. Users can control the transfer of information from their personal communication device to other devices.

Parties may specify authentication procedures. A party may be authenticated for one or more third parties and may be authenticated in a manner without disclosing some or all of the party's personal information to the one or more third party.

An example of operation of one possible mode of the DDPS is as follows. A consumer, Mary, enters an enrollment center in order to enroll in the DDPS. After verification of Mary's identity, Mary's user data is entered into an enrollment computer which is linked to a control computer which processes enrollments, authenticates previously enrolled users or merchants, and processes transactions among authenticated merchants, consumers, and/or devices. The control computer compares Mary's user data to databases wherein positive comparisons permit Mary to enroll. After enrollment, Mary may access the DDPS through a merchant computer, her computer, her cell phone, or other devices linked to the control computer in order to authenticate herself and to conduct transactions.

Other features and embodiments will appear from the following description and appended claims, reference being made to the accompanying drawings forming a part of this specification wherein like reference characters designate corresponding parts in the several views.

### GLOSSARY

1. User: person, association, entity, merchant, financial agent, enrollment agent, and/or administrator; holder of a user key.
2. Merchant: user engaged in the exchange of goods and/or services for consideration; holder of a merchant access key.
3. Financial agent: holder of a financial access key; can create a user key and/or a merchant access key.
4. Enrollment agent: holder of an enrollment access key; can create a financial access key.
5. Administrator: administrator of the system; holder of an administrator access key; can create an enrollment access key.
6. Enrollment operator: oversees and/or facilitates the new user and/or new merchant enrollment processes.
7. Merchant operator: oversees and/or facilitates a transaction with a merchant.
8. Key: unique symbol identifying an intended holder.
9. Card: portable device comprising a key encoded in a printed and/or electronically stored media.
10. Authenticate: to verify the identity of a person, association, entity, and/or apparatus.
11. Digital signature: alphanumeric identification code which can be used to authenticate an electronic data segment.
12. Transaction: operation involving one or more parties which comprises the transfer of consideration, the transfer of goods and/or services, the exchange of consideration, the exchange of goods and/or services, the exchange of consideration for goods and/or services, and/or the authentication of one or more parties and/or devices.
13. Client device: computer and/or other device linked to the control computer.
14. Web server: hardware and/or software having the capability to interface to the internet, and/or a intranet, and/or another computer network.
15. User identity data: data which may identify a user.
16. Merchant identity data: data which may identify a merchant.

### BRIEF DESCRIPTION OF THE DRAWINGS

Exemplifying embodiments are illustrated in referenced figures of the drawings. It is intended that the embodiments and figures disclosed herein are to be considered illustrative rather than limiting. Also, the terminology used herein is for the purpose of description and not of limitation.

FIG. 1 is a schematic view of hardware that may be utilized in various embodiments.

FIG. 2 is a data flow diagram of the system of FIG. 1.

FIG. 3 is a diagram of an administrator access key creation process.

FIG. 4 is a diagram of a user key creation process.

FIG. 5 is a diagram of a process of creating keys subsequent to the creation of an administrator access key.

FIG. 6 is an illustration of a typical access or user card.

FIG. 7A is a schematic diagram of a first time on-line key access to a control computer.

FIG. 7B is a schematic diagram of an on-line key access to a control computer subsequent to initial login.

FIG. 8A is a schematic diagram of access key authentication using a digital signature linked to a user name.

FIG. 8B is a schematic diagram of access key authentication using a random digital signature.

FIG. 9 is a schematic diagram of a transaction approval process.

FIG. 10 is a schematic diagram of an on-line transaction with an e-commerce merchant.

FIG. 11 is a schematic diagram of a real world transaction.

FIG. 12 is a schematic diagram of an on-line remote user registration and authentication process for future user logins to a merchant server.

FIG. 13 is an illustration of various keys and profiles that may be enabled under various embodiments.

FIG. 14 in an illustration of examples of graphical user interfaces (GUIs) which may be presented to individuals.

FIG. 15 is a schematic diagram of how financial transactions are processed in one embodiment.

FIG. 16 is a schematic diagram of a personal client device acting as a terminal.

FIG. 17 is a schematic diagram of the operation of a personal communication device containing a web server and its interaction with other devices.

FIG. 18 is a schematic diagram of the operation of various security features that may be implemented.

FIG. 19 is a schematic diagram of the operation of an access or user card comprising an operating system.

FIG. 20 is a schematic diagram of an alternative embodiment of the system described in FIGS. 1 and 2.

FIG. 21 is a schematic diagram of another alternative embodiment of the system described in FIGS. 1 and 2.

FIG. 22 is a schematic diagram of another alternative embodiment of the system described in FIGS. 1 and 2.

FIG. 23 is a schematic diagram of another alternative embodiment of the system described in FIGS. 1 and 2.

FIG. 24 is a schematic diagram of another alternative embodiment of the system described in FIGS. 1 and 2.

Before explaining the disclosed embodiment(s) in detail, it is to be understood that the following appended claims and claims hereafter introduced are not limited to the details of the particular arrangement(s) shown, since the following appended claims and claims hereafter introduced are capable of other embodiments. Also, the terminology used herein is for the purpose of description and not of limitation.

### DETAILED DESCRIPTION OF THE DRAWINGS

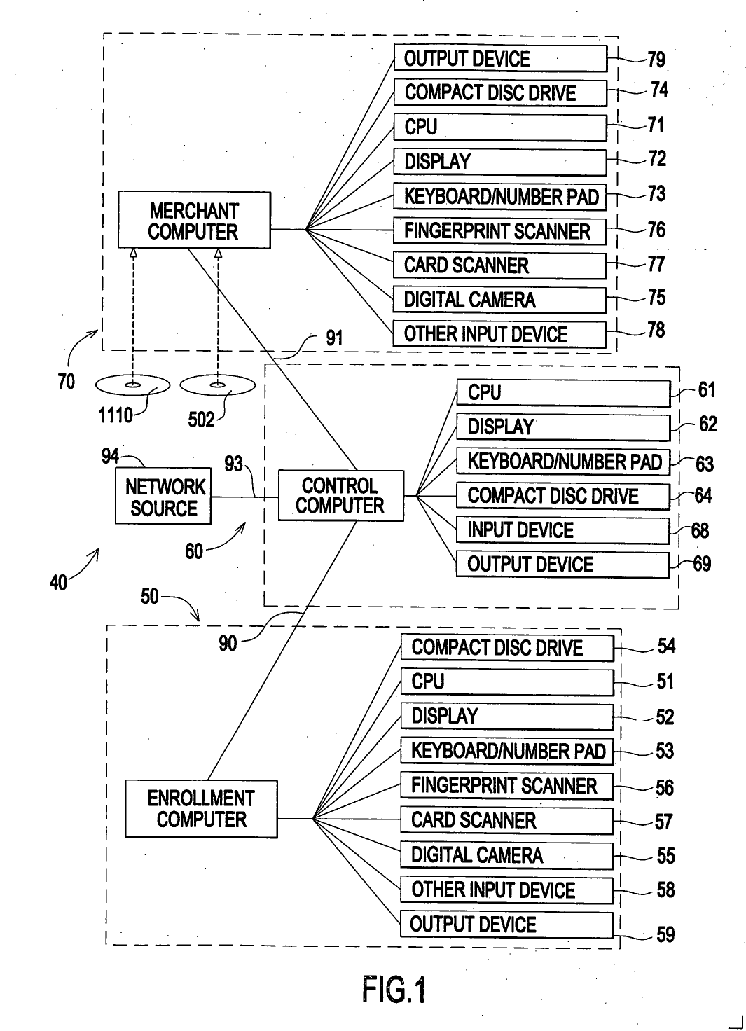

FIG. 1 is an embodiment of a user authentication and secure transaction system comprised of enrollment computer 50, control computer 60 in electronic communication with enrollment computer 50, merchant computer 70 in electronic communication with control computer 60, and user key 502. Some embodiments of system 40 may also include merchant access key 1110. It is to be understood that the system illustrated in FIG. 1 and described in the description of FIG. 1 can have a single occurrence of each component or person or a plurality of one or more components or persons as required by the needs of the system applications.

In FIG. 1, enrollment computer 50 is comprised of central processing unit (CPU) 51, display 52, and keyboard/number pad 53. These components are well known in the art, and should generally meet requirements for system 40 data processing and network communications. For example, CPU 51 should have the computing power necessary to drive display 52 and any output devices 59 (as described in more detail below), receive input from keyboard/number pad 53 and other input devices 58 (if any, as described in more detail below), and communicate over computer network 90 with control computer 60, as described in more detail below.

Display 52 may be in direct or indirect electronic communication with CPU 51. Display 52 may comprise a cathode ray tube (CRT), liquid crystal display, or other type of equivalent optical display, as long as display 52 is electronically compatible with CPU 51.

Keyboard/number pad 53 may be in direct or indirect electronic communication with CPU 51. Keyboard/number pad 53 may be any standard form of keyboard, and/or number pad, or equivalent, as long as keyboard/number pad 53 is electronically compatible with CPU 51.

In some embodiments of system 40, central processing unit (CPU) 51, display 52, and keyboard/number pad 53 may take the form of a standard point of sale system commonly known in the art or equivalent thereto. In addition, enrollment computer 50 may comprise compact disc drive 54 that may be in direct or indirect electronic communication with CPU 51. Compact disc drive 54 may be of a type currently known in the art or equivalent.

Enrollment computer 50 may further comprise digital camera 55 in direct or indirect electronic communication with CPU 51. Digital camera 55 may be suitable for taking a person's portrait (e.g. a passport photo).

Enrollment computer 50 may further comprise fingerprint scanner 56 in direct or indirect electronic communication with CPU 51. Fingerprint scanner 56 may be suitable for scanning a person's fingerprints or thumbprints.

Enrollment computer 50 may further comprise card scanner 57 in direct or indirect electronic communication with CPU 51. Card scanner 57 may be suitable for scanning the magnetic stripe of a card, the integrated circuit or other electronic processor of a smart card, or equivalents thereof. For example, card scanner 57 may comprise a three-track card reader capable of reading magnetic stripes on credit cards, or a card scanner used in retail purchase transactions involving smart cards. Examples of cards that may be read by card scanner 57 comprise driver's licenses, credit cards, debit cards, smart cards, military identification cards, other identification cards, or any combination of such cards.

Enrollment computer 50 may further comprise other input device 58 that may be used to collect and process information, which type of input device 58 may be currently known in the art or equivalent thereto. In these embodiments, other input device 58 may be in direct or indirect electronic communication with CPU 51. An example of other input device 58 may be a retina scanner, which may be suitable for scanning a person's retina (such as for personal identification purposes), which type of retina scanner may be currently known in the art or equivalent thereto.

Enrollment computer 50 may further comprise output device 59 suitable for displaying or recording data and information produced by CPU 51. Output device 59 may be suitable for displaying or recording data and information (e.g. a printer), which type of output device 59 may be currently known in the art or equivalent thereto. In these embodiments, output device 59 may be in direct or indirect electronic communication with CPU 51.

System 40 also comprises control computer 60 having central processing unit (CPU) 61. Control computer 60 may further comprise display 62. However, a display 62 is not required. Control computer 60 may further comprise keyboard/number pad 63. However, a keyboard/number pad 63 is not required. These components are well known in the art, and should meet the requirements for system 40 data processing and network communications. For example, CPU 61 should have the computing power necessary to drive display 62 (if any, as described in more detail below) and output device 69 (if any, as described in more detail below), receive input from keyboard/number pad 63 (if any, as described in more detail below) and other input device 68 (if any, as described below), communicate over computer network 91 with merchant computer 70, and communicate over computer network 90 with enrollment computer 50.

Display 62, if any, may be in direct or indirect electronic communication with CPU 61 and may be comprised of a CRT, liquid crystal display, or other type of optical display currently known in the art or equivalents thereof, as long as display 62 can be electronically compatible with CPU 61. Keyboard/number pad 63, if any, may be in direct or indirect electronic communication with CPU 61 and may be any standard form of keyboard, number pad, or both currently known in the art or equivalents thereof, as long as keyboard/number pad 63 can be electronically compatible with CPU 61.

Control computer 60 may further comprise compact disc drive 64 in direct or indirect electronic communication with CPU 61. Compact disc drive 64 may be of a type commonly used with computers, where such types are currently known in the art or equivalent thereto.

Control computer 60 may further comprise additional input device 68 that may be used to collect and process information, which type of input device 68 is currently known in the art or equivalent thereto. In this embodiment, additional input device 68 may be in direct or indirect electronic communication with CPU 61. An example of additional input device 68 may be a retina or finger print scanner.

Control computer 60 may further comprise output device 69 suitable for displaying or recording data and information produced by CPU 61. Output device 69 may be suitable for displaying or recording data and information (e.g. a printer), which type of output device 69 may be currently known in the art or equivalent thereof. In this embodiment, additional output device 69 may be in direct or indirect electronic communication with CPU 61.

System 40 also comprises merchant computer 70. In this embodiment, merchant computer 70 comprises central processing unit (CPU) 71. Merchant computer 70 may further comprise display 72. However, a display 72 is not required. Merchant computer 70 may further comprise keyboard/number pad 73. However a keyboard/number pad 73 is not required. These components are well known in the art, and should meet the requirements for system 40 data processing and network communications. For example, CPU 71 should have the computing power necessary to drive display 72 (if any, as described in more detail below) and output device 79 (if any, as described in more detail below), receive input from keyboard/number pad 73 (if any, as described in more detail below) and other input device 78 (if any, as described in more below), and communicate over computer network 91 with control computer 60, as described in more detail above.

Display 72, if any, may be in direct or indirect electronic communication with CPU 71 and may be comprised of a CRT, liquid crystal display, or other type of optical display currently known in the art or equivalent thereto, as long as display 72 may be electronically compatible with CPU 71. Keyboard/number pad 73, if any, may be in direct or indirect electronic communication with CPU 71 and may be any standard form of keyboard, number pad, or both currently known in the art or equivalents thereof, as long as keyboard/number pad 73 can be electronically compatible with CPU 71.

Central processing unit (CPU) 71, display 72 (if any), and keyboard/number pad 73 (if any) may take the form of a standard point of sale system commonly known in the art or equivalent thereto. Merchant computer 70 may further comprise compact disc drive 74 in direct or indirect electronic communication with CPU 71. Compact disc drive 74 may be of a type commonly used with computers, where such types are currently known in the art or equivalent thereto.

Merchant computer 70 may further comprise digital camera 75 in direct or indirect electronic communication with CPU 71. Digital camera 75 may be suitable for taking a person's portrait (such as a passport photo), which type of digital camera 75 may be currently known in the art or equivalent thereto.

Merchant computer 70 may further comprise fingerprint scanner 76 in direct or indirect electronic communication with CPU 71. Fingerprint scanner 76 may be suitable for scanning a person's fingerprints or thumbprints (e.g. for law enforcement purposes), which type of fingerprint scanner may be currently known in the art or equivalent thereto.

Merchant computer 70 may further comprise card scanner 77 in direct or indirect electronic communication with CPU 71. Card scanner 77 may be suitable for scanning the magnetic stripe of a card or the integrated circuit or other electronic processor of a smart card, which type of card scanner may be currently known in the art or equivalent thereto. For example, card scanner 77 may comprise a three-track card reader capable of reading magnetic stripes on credit cards or a card reader used in retail purchase transactions involving smart cards. Examples of cards that may be read by card scanner 77 comprise drivers' licenses, credit cards, debit cards, smart cards, military identification cards, other identification cards, or any combination of such cards.

Merchant computer 70 may further comprise other input device 78 that may be used to collect and process information, which type of input device 78 may be currently known in the art or equivalent thereto. In these embodiments, other input device 78 may be in direct or indirect electronic communication with CPU 71. An example of other input device 78 may be a retina scanner, which may be of a type suitable for scanning a person's retina (e.g. for personal identification purposes), which type of retina scanner may be currently known in the art or equivalent thereto. Another example of other input device 78 may be a uniform product code (UPC) scanner, which may be of a type suitable for scanning the UPC symbols on products (e.g. for use in retail point of sale purchase systems), which type of UPC scanner may be currently known in the art or equivalent thereto.

Merchant computer 70 may further comprise output device 79 suitable for displaying or recording data and information produced by CPU 71. Output device 79 may be suitable for displaying or recording data and information (e.g. a printer), which type of output device may be currently known in the art or equivalent thereto. In these embodiments, output device 79 may be in direct or indirect electronic communication with CPU 71.

In this embodiment of system 40, enrollment computer 50 has an interface for communicating with control computer 60 over computer network 90. Control computer 60 has an interface for communicating with enrollment computer 50 over computer network 90 and an interface for communicating with merchant computer 70 over computer network 91. Merchant computer 70 has an interface for communicating with control computer 60 over computer network 91. In each case, and in various embodiments of system 40, the computer networks 90 and 91 may be the Internet, a local area network (LAN), a wide area network (WAN), a wireless network (such as WIFI), or any other type of computer network currently known in the art or equivalent thereto, or any combination of such computer networks. The interface for connecting enrollment computer 50, control computer 60, and merchant computer 70 over computer networks 90 and 91 may be any type of electronically compatible device that may be used to connect computers to one another by means of networks 90 and 91. Examples of such devices comprise modems, or any other type of computer network interface devices currently known in the art or equivalent thereto, or any combination of such devices.

Control computer 60 may further comprise an interface for communicating over computer network 93 with additional computer network source 94. For example, control computer 60 may be in electronic communication with network source 94 communicating over network 93 operated by a credit card company for purposes of obtaining approval of transactions involving the use of credit cards. Another example may be control computer 60 communicating electronically with network source 94 comprising computers used by customer service, system administrative, and/or management personnel to access the various databases and logs maintained within control computer 60. Various configurations of hardware can allow for one or more computer variations with respect to a user, merchant, financial, and/or central control. That is, hardware and/or software can be combined in various combinations depending on the customer's needs.

In these embodiments, the interface for connecting control computer 60 over computer network 93 may be any type of electronically compatible device that may be used to connect computers to one another by means of network 93. Examples of such devices are the same as those listed above in this paragraph related to networks 90 and 91.

Control computer 60 may be located in a high security facility to help prevent unauthorized physical access. Control computer 60 may also be electronically secured by high security hardware and/or software to prevent unauthorized electronic access. Merchant computer 70 may be located in a retail store or other facility with a lower degree of physical security and/or electronic security than control computer 60. Enrollment computer 50 may be available for the general public to access and thus may be of relative lower security than merchant computer 70 and/or control computer 60.

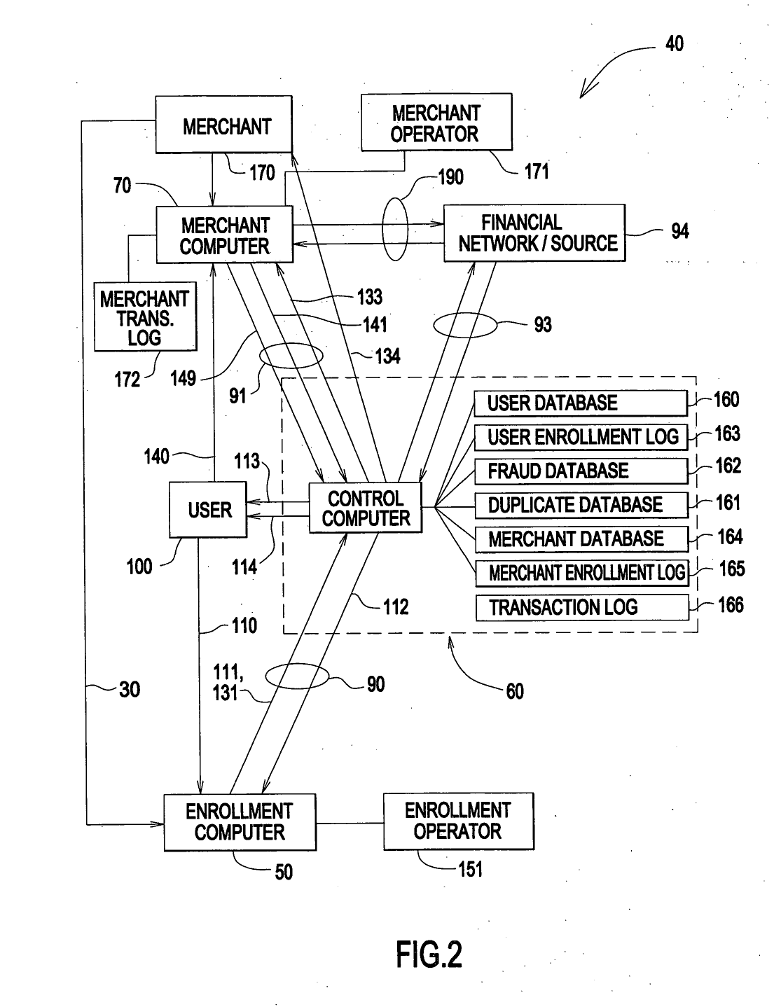

FIG. 2 is a data flow diagram of system 40. Here, system 40 is described in terms of a user enrollment process, a merchant enrollment process, and a transaction process. By way of example and not of limitation, system 40 can be used for a variety of functions such as to verify the identity of a person seeking access to a secure area, seeking access to a secure network, seeking access to conduct a secure financial transaction, and/or engaging in similar actions. A financial transaction conducted over a computer network, such as the Internet, or by means of a credit or debit card at a retail location is referred to herein as an “Economic Transaction”. It is to be understood that the system illustrated in FIG. 2 and described in the description of FIG. 2 can have a single occurrence of each component or person or a plurality of one or more components or persons as required by the needs of the system applications.

Enrollment computer 50 may be used by user 100 and/or merchant 170 to enroll in system 40. System 40 may further comprise enrollment operator 151 supervising and/or operating enrollment computer 50.

User 100, or someone acting on that person's behalf, may enter user identity data 110, that is unique to user 100, into enrollment computer 50. Alternately, merchant 170, or someone acting on merchant's 170 behalf, may enter merchant identity data 130, that is unique to merchant 170, into enrollment computer 50. If desired, enrollment operator 151 may input user identity data 110 and/or merchant identity data 130 into enrollment computer 50, verify, and/or alter user identity data 110 or merchant identity data 130.

By way of example and not of limitation, user identity data 110 may comprise information such as user's 100 name, postal address, telephone number(s), email address, social security number, date of birth, driver's license information, fingerprints, thumbprints, photograph, retina scan, voice recognition segment, credit card information, computer's internet protocol address, and/or other personally identifiable data and information. Merchant identity data 130 may comprise merchant's 170 name, postal address, telephone number(s), email address, employer identification number, computer's internet protocol address, and/or other identifiable data and information. In addition, merchant identity data 130 may comprise data and/or information related to merchant's 170 principal and representatives and/or persons operating merchant computer 70 (merchant operators 171), such as date of birth, driver's license information, fingerprints, thumbprints, photograph, retina scan, voice recognition segment, and/or other personally identifiable data and information.

In some embodiments, user 100 may select and input a unique user name, a user password, or both into enrollment computer 50. Merchant 170 may select and enter into enrollment computer 50 a unique merchant name, merchant password, or both. A user name, user password, merchant name, and merchant password must meet designated system 40 constraints (such as minimum and maximum number of characters, and limited character types). In other embodiments, enrollment computer 50, control computer 60, and/or enrollment operator 151 may assign a user name and user password to user 100 and a merchant name, and merchant password to merchant 170.

Enrollment computer 50 uploads user identity data 110 as uploaded user identity data 111 and merchant identity data 130 as uploaded merchant identity data 131 to control computer 60 by means of computer network 90. If desired, enrollment computer 50 may also date/time stamp, certify, and/or encrypt uploaded user identity data 1111 and/or uploaded merchant identity data 131 prior to upload. Certification and/or encryption may be completed by any means currently known in the art or equivalent thereof. For example, such encryption may be by means of HTTPS 128 bit encryption as well as asymmetric, or symmetric methods such as public key.

A portion of user identity data 110 or merchant identity data 130 may be designated as “verification data”, which is data verifiable by means of system 40 in order to authenticate a party or authorize a transaction. For example, if verification data consists of information comprising driver's license information, a left thumbprint, a left retina scan, and a photograph, then the person seeking to complete the transaction must enter information which matches the verification data in order to complete the transaction.

User 100 and/or enrollment operator 151 have the authority to choose the content of user identity data 110 and/or user verification data within system 40 constraints. Merchant 170 and/or enrollment operator 151 have the authority to choose the content of merchant identity data 130 and/or merchant verification data within system 40 constraints. However, any combination of data selection points could be preset for entry. For example, system 40 may permit user 100 to designate only driver's license data, a first left hand index fingerprint, a left eye retina scan, and a voiceprint or any combination thereof, but no other user data, as verification data. In another embodiment, it may be enrollment computer 50, enrollment operator 151, and/or control computer 60 which designate all or a portion of the verification data.

As illustrated in FIG. 2, control computer 60 may comprise user database 160, duplicate database 161, fraud database 162, user enrollment log 163, merchant database 164, merchant enrollment log 165, and/or transaction log 166.

In various embodiments of system 40, control computer 60 may decrypt uploaded data if necessary. Decryption may be completed by any means currently known in the art or equivalent thereof that correspond to a means used to encrypt such data and information. For example, such decryption may be by means of public key. Additionally, control computer 60 may date/time stamp, certify, and or encrypt any information or messages sent by control computer 60 to other computers, devices, and/or persons. Certification and/or encryption may be completed by any means currently known in the art or equivalent thereof.

User database 160 houses uploaded user identity data 111, and other data and information related to user 100 that has been entered into enrollment computer 50, or the “user profile” for user 100. During user enrollment, control computer 60 may compare uploaded user identity data 111 to user data stored in database 160. If all or a portion of uploaded user identity data 111 matches data already housed in user database 160, various actions may occur. For example, user enrollment may be denied, uploaded user identity data 111 may be added to duplicate database 161, or enrollment with duplicate user data may be recorded in user's 100 user profile in user database 160.

Merchant database 164 houses uploaded merchant identity data 131, and other data and information related to merchant 170 that has been entered into enrollment computer 50, or the “merchant profile” for merchant 170. During merchant enrollment, control computer 60 may compare uploaded merchant identity data 131 to data stored in merchant database 164. If all or a portion of uploaded merchant identity data 131 matches data already housed in merchant database 164, various actions may occur. For example, merchant enrollment may be denied, uploaded merchant identity data 131 may be added to duplicate database 161, or enrollment with duplicate merchant identity data may be recorded in merchant's 170 profile in merchant database 164.

In circumstances where user database 160 already contains user's 100 user profile or a portion of user's 100 uploaded user identity data 111, duplicate database 161 may comprise data and information related to users 100 who have entered user identity data 110 into enrollment computer 50. Additionally, duplicate database 161 may comprise data and information related to merchants 170 who have entered merchant identity data 130 into enrollment computer 50 and where merchant database 164 already contains merchant's 170 merchant profile or a portion of that merchant's 170 uploaded merchant identity data 131.

In some embodiments, some or all actions of control computer 60 may be logged in one or more databases. Such logging may comprise recording the date, time, type, and/or location of the transaction. Additionally, such logging may comprise recording the user 100, merchant 170, merchant operator 171, enrollment operator 151, and/or computer(s) involved in the action. For example, control computer 60 may store a record of user 100 enrollment in user enrollment log 163 and/or a record of merchant 170 enrollment in merchant enrollment log 165. User enrollment log 163 and merchant enrollment log 165 may be databases housing information related to user 100 or merchant 170 respectively, as well as the time and date of enrollment, the identity of a specific enrollment computer 50 from which user identity data 100 or merchant identity data 131 was received, and/or other information related to enrollment. In another example, some or all completed and/or attempted transactions may be logged in transaction log 166.

Fraud database 162 may comprise data and information related to people and entities known to engage in, who are suspected of engaging in, and/or who are victims of fraudulent, criminal, or prohibited activities related to the purpose for which system 40 is being used. For example, fraud database 162 may comprise information regarding convicted and/or suspected identity thieves. Fraud database 162 may also comprise information regarding people who have been victims of fraud. Data and information for a given person or entity stored in fraud database 162 may be referred to as the “fraud profile” for such person or entity. Data obtained during user or merchant enrollment and/or during transactions may be compared against data housed in fraud database 162. If there is a match, various actions could occur. For example, the enrollment or transaction could be denied, the user or merchant access key could be confiscated or disabled, or authorities could be notified.

Although not required, control computer 60 may send message 112 to enrollment computer 50 providing information to, requesting information from, and/or requesting action from user 100, merchant 170, and/or enrollment operator 151. For example, message 112 may state that enrollment is complete, enrollment was denied, or that enrollment operator 151 should take further action. Control computer 60 may also send message 113 to user 100 and/or message 133 to merchant computer 70 via email or other electronic communication means to a specific email address or other electronic address. For example, such message could state that enrollment has been completed or that enrollment has been denied. In some embodiments, the email or other electronic message 133 sent to merchant computer 70 may also include merchant software that may be used in the operation of merchant computer 70, as described in more detail below.

Control computer 60 may assign a user identifier to user 100 that is unique to user 100 and/or a merchant identifier to merchant 170 that is unique to merchant 170. The user identifier is storable in the user profile in user database 160 and the merchant identifier is storable in the merchant profile of merchant database 164. Although the user identifier and/or merchant identifier may be comprised of a hardware identification signature, other types of identifying means could be employed, such as those having serialized encryption means. The user identifier may also be recordable in digital format, along with the user name of user 100, and encrypted on a user key 502 issued to user 100, as described below. The merchant identifier may also be recordable in digital format, along with the merchant name of merchant 170, and encrypted on a merchant access key 1110 issued to merchant 170, as described below. Other data and information may also be recorded on user key 502 and merchant access key 1110. Similarly, this other data and information may also be encrypted.

As stated above, the user identifier may be digitally recorded on user key 502 and the merchant identifier may be digitally recorded on merchant access key 1110 by control computer 60. However, the user identifier and/or the merchant identifier may also be recorded by another computer, such as a computer operated by a third party that is in the business of recording such data, if desired. User key 502 and merchant access key 1110 may be delivered 114, 134 to user 100 or merchant 170 respectively by standard delivery means (such as by mail or courier). User key 502 and/or merchant access key 1110 can comprise limited data to necessitate interactive authentication with control computer 60, thereby minimizing damages by theft and/or copying of user key 502 and/or merchant access key 1110.

When merchant 170 desires to activate the merchant software on merchant computer 70 to use system 40 to verify the identity of a person, merchant 170 places the merchant access key 1110 into merchant computer 70. In some cases, merchant 170 may change a portion of merchant's 170 uploaded merchant identity data 131 storable in merchant database 164 by use of merchant computer 70.

In some embodiments, user 100 inserts 140 user key 502 (on which may be recorded user's 100 user name and unique user identifier) into merchant computer's 70 compact disc drive (or interfaces user key 502 to merchant computer 70 in another manner) when user 100 seeks to complete a transaction (e.g. gain access to a secure area, network, purchase transaction). Although merchant computer 70 may be located at the point of desired access to a secure area or at a retail location as part of a point of sale system, it can be locatable as desired. Insertion 140 of user key 502 into merchant computer's 70 compact disc drive (or interfacing user key 502 to merchant computer 70 in another manner) may activate the merchant software which instructs merchant computer 70 to read the user's 100 user name and user identifier from user key 502. In one embodiment of the system, merchant computer 70 also requests that user 100 enter user's 100 user name and password into merchant computer 70. Merchant computer 70 combines merchant's 170 merchant name and the merchant identifier with user's 100 user name, user identifier, and password to create authorization data 141, and uploads authorization data 141 to control computer 60 by means of computer network 91. In some embodiments, merchant computer 70 may also record the transmission of authorization data 141 in merchant transaction log 172, which is a database comprising information related to transactions involving merchant computer 70 and maintainable within merchant computer 70. Merchant computer 70 may also date/time stamp, certify, and/or encrypt authorization data 141 prior to uploading such data to control computer 60. Certification and/or encryption may be completed by any means currently known in the art or equivalent thereof.

In one embodiment, control computer 60 may decrypt authorization data 141 when computer 60 receives authorization data 141, if necessary. The decryption may be by any means currently known in the art or equivalent thereof that corresponds to the means used to encrypt such data.

After receipt and/or decryption if necessary of authorization data 141, control computer 60 may authenticate authorization data 141 before proceeding to process the transaction. For example, control computer 60 may check to see if the merchant and/or user information match information stored in control computer's 60 database(s). Such authentication may include, but is not limited to, checking to insure that authorization data 141 does not match data in fraud database 162. If control computer 60 is unable to authenticate authorization data 141, control computer 60 may take various actions. For example, control computer 60 may terminate the transaction. In another example, control computer 60 may send message 133 to merchant computer 70 providing information to, requesting information from, and/or requesting action from user 100, merchant 170, and/or merchant operator 171. For example, control computer 60 may send message 133 requesting that merchant operator 171 terminate the transaction and/or confiscate user's 100 user key 502.

If control computer 60 is able to authenticate authorization data 141, control computer 60 may continue to process the transaction. Control computer 60 may determine the type of verification data required to complete the transaction. The type of required verification data may be defined by user's 100 preferences storable in user's 100 profile and/or merchant's 170 preferences storable in merchant's 170 profile. Control computer 60 sends message 133 to merchant computer requesting user 100, merchant 170, and/or merchant operator 171 enter the required verification data. In some embodiments, if the verification data requires verification from merchant operator 171, message 133 may include a portion of user's 100 verification data. For example, if user's 100 verification data requires driver's license information, a photograph, and a left thumbprint, user 100 may swipe user's 100 driver's license through the card scanner and place a left thumb on the fingerprint scanner which are a part of merchant computer 70. To finalize verification, in this example, merchant operator 171 may review whether a photograph of user 100 received in message 133 from control computer 60 matches the identity of user 100 and corroborate verification of the photograph by pressing a key of the keyboard/number pad of merchant computer 70. Message 133 requesting verification information may also contain instructions for merchant computer 70 to take certain action(s) (e.g. deny access, keep user key 502).

When prompted by merchant computer 70, user 100 enters any requested verification data into merchant computer 70, and merchant operator 171 (if any) enters any information requested by control computer 60 that must be provided by merchant operator 171 (if any) into merchant computer 70, and merchant computer 70 completes any instructions received from control computer 60. All such entered verification data and information is uploaded by merchant computer 70 in message 149 to control computer 60 by means of computer network 91. Merchant computer 70 may record the transmission of message 149 in merchant transaction log 172. Merchant computer 70 may also date/time stamp, certify, and/or encrypt message 149 before transmission. Certification and/or encryption may be completed by any means currently known in the art or equivalent thereof.

When control computer 60 receives the verification data in message 149 from merchant computer 70, control computer 60 may decrypt message 149 if necessary. The decryption may be by any means currently known in the art or equivalent thereof that corresponds to means used to encrypt such data and information.

In some embodiments, control computer 60 attempts to authenticate verification data received in message 149 before continuing to process the transaction. Authentication procedures may comprise comparing the verification data to user's 100 user profile storable in user database 160 and/or fraud database 162. If control computer 60 is unable to authenticate the verification data (e.g. it does not match data in user's 100 user profile, matches data in fraud database 162), control computer 60 may take one or more actions. For example, in these cases control computer 60 may terminate the transaction. In another example, control computer 60 may send message 133 to merchant computer 70 sending information to, requesting information from, or requesting action from user 100, merchant 170, and/or merchant operator 171. For example, control computer 60 may send message 133 to user 100 stating that the transaction is denied or may send message 133 to merchant operator 171 requesting that authorities be called.

If control computer 60 is able to authenticate the verification information, control computer 60 sends message 133 to merchant computer 70 to authorize the transaction. For example, merchant computer 70 may be instructed to unlock a door to a restricted area or allow a person access to a secure network.

In some cases, message 133 authorizing the transaction may also provide additional information to, and request additional data and information from, merchant computer 70. For example, if the transaction is a purchase of goods or services, control computer 60 may provide a list of payment cards that may be used to make the purchase (which have been previously entered as user identity data 110 by user 100 during the user enrollment process), and prompt user 100 to enter the choice of desired payment cards into merchant computer 70. User 100 may enter the choice of payment card and merchant operator 171 may enter the amount of the purchase into merchant computer 70. Merchant computer 70 may date/time stamp, certify, and/or encrypt such information (transaction data) and upload it to control computer 60. Certification and/or encryption may be completed by any means currently known in the art or equivalent thereof. Control computer 60 may electronically submit pertinent portions of the user data, merchant data, and transaction data to network source 94 (such as a bank by means of computer network 93) for approval of a payment card purchase, as designated by instructions contained in merchant's 170 merchant profile in merchant database 164. If control computer 60 receives approval for the payment card transaction from network source 94, control computer 60 may send message 133 to merchant computer 70 stating that the purchase transaction has been approved. Such message 133 may also instruct merchant computer 70 to take certain action, such as to open the compact disc drive in which user key 502 may be located and print a receipt for the transaction.

If control computer 60 receives a denial of authorization for a payment card transaction from network source 94, control computer 60 may send message 133 to merchant computer 70 that the purchase transaction has been denied. Such message 133 may also comprise instructions to merchant computer 70 to take certain action, such as to refuse to return user key 502 to the user 100, or also instructions to merchant operator 171 (if any) to take certain action, such as confiscate user key 502 and contact law enforcement personnel.

As another alternative, rather than processing the purchase transaction through control computer 60, message 133 sent from control computer 60 to merchant computer 70 prompting choice of payment card may also instruct merchant computer 70 to combine the transaction data entered into merchant computer 70 in response to the prompt with other designated user data, and/or merchant data, and contact network source 94 directly over communication medium 190 for approval of the purchase. In such cases, authorization message 133 sent to merchant computer 70 from control computer 60 may also comprise a key necessary to receive approval by means of network source 94.

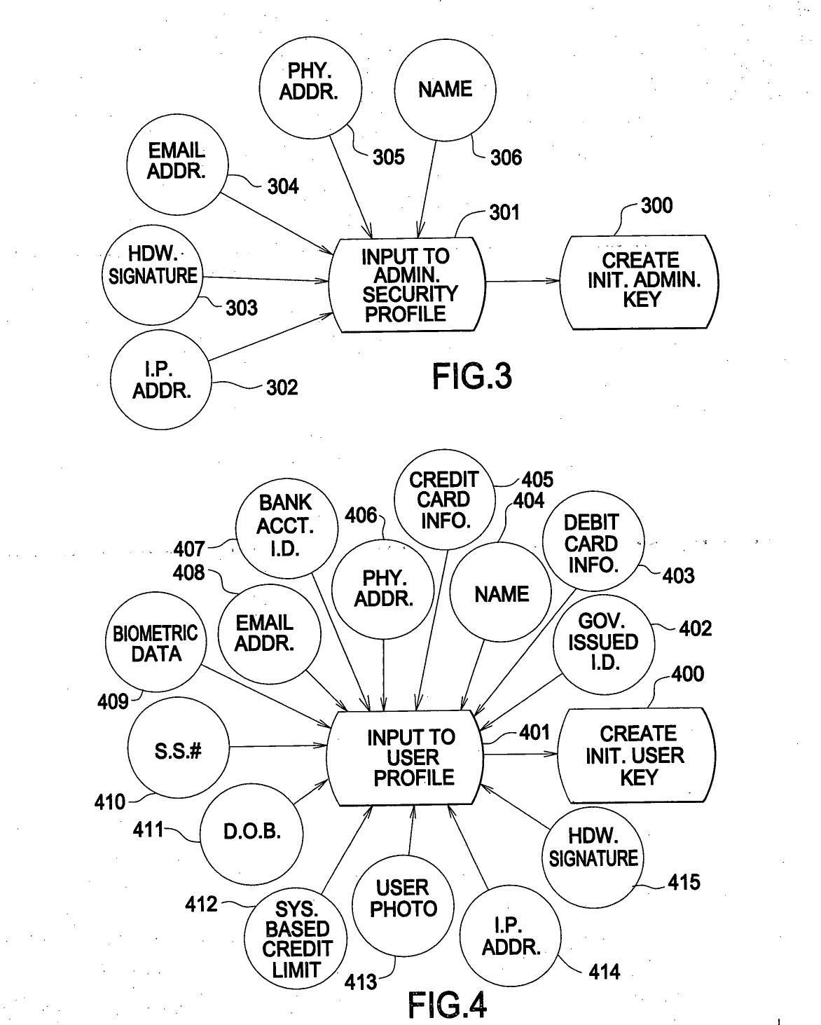

FIG. 3 is a diagram of an administrator access key creation process. By way of example and not of limitation, administration security profile input 301 may comprise various data including name 306, physical address 305, email address 304, client hardware identification signature 303, and internet protocol (“IP”) address 302. All data may be entered via system graphical user interface (“GUI”). After data is entered 301, internal software creates administrator access key 300.

FIG. 4 is a diagram of a user key creation process. Data may be entered 401 into a GUI interface. By way of example and not of limitation, data entry points may comprise data such as name 404, physical mailing address 406, email address 408, social security number 410, date of birth 411, IP address 414, hardware identification signature 415, user photo 413, and/or government issued I.D. 402 which could be swiped as a means of input. FIG. 4 also shows optional information that may be entered such as debit card information 403, credit card information 405, bank account information 407, biometric data 409, and/or system based credit limit 412. For example, biometric data may comprise information such as fingerprints, retina scans, voice recognition, and/or facial recognition. After data is entered 401 into the user profile, initial user key is created 400. The data entry depicted in FIG. 4 may also be used to create subsequent user access keys for enrollment agents, financial agents, merchants and users. In some instances, not all of the inputs are used, whereas in some instances, additional inputs may be desired.

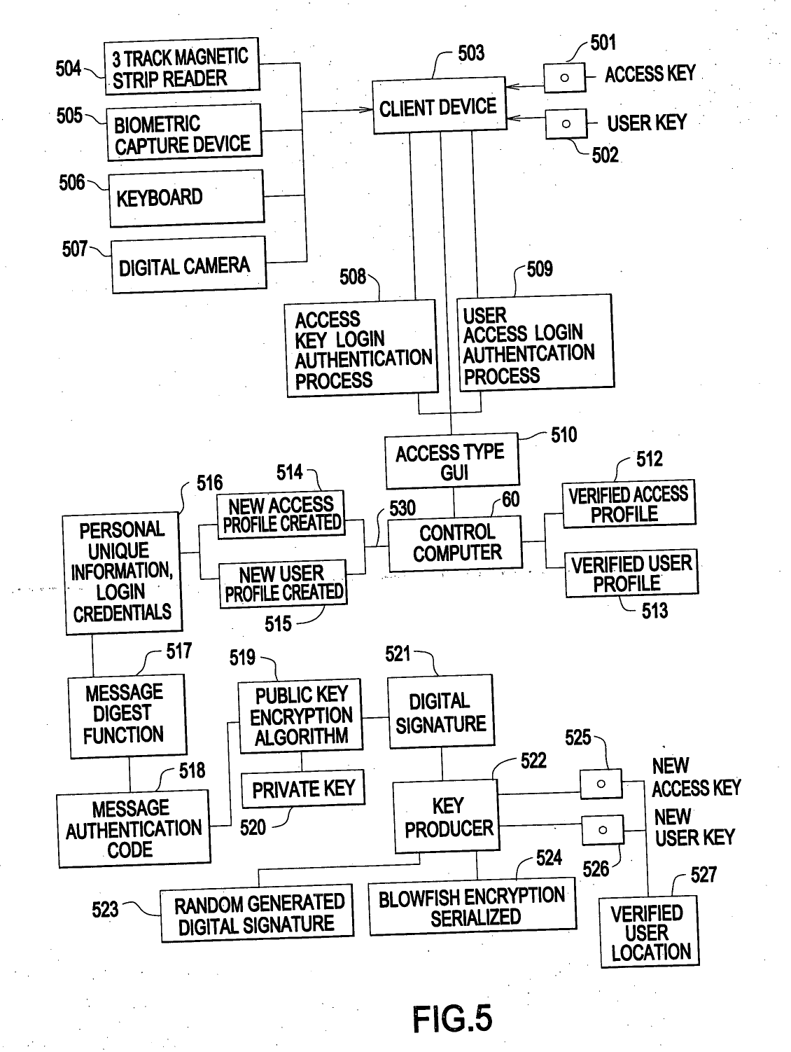

FIG. 5 is a diagram of a process of creating keys subsequent to the creation of an administrator access key. The process can be a reiterative type process for use by various users including administrators, enrollment agents, and financial agents to create access keys for appropriate agents. A hierarchical key creation protocol could be as follows: an administrator could create an enrollment access key as well as an enrollment agent user key; an enrollment agent could create a financial access key as well as a financial agent user key; a financial agent could create a merchant access key, a merchant user key, and/or a base user key.

A key creation process could begin with having a key creator (i.e. administrator, enrollment agent, or financial agent) enter an access key 501 and user key 502 via an access card. In FIG. 5, inputs are made at client device 503. By way of example and not of limitation, client device 503 may comprise I/O devices such as three track magnetic strip reader 504, biometric capture device 505, keyboard 506, and/or digital camera 507.

However, other devices as required may be implemented. The access key login matches user information against the current profiles or duplicate information to complete the access key authentication process 508. User key 502 information may also be matched against a user profile in the user access login authentication process 509.

After authentication, access GUI 510 is enabled, and control computer 60 verifies access profile 512 and user profile 513. The hardware fingerprint and IP restriction security features become NULL when login is conjoined with access key 501. Whereby, the authentication process is complete 530 and information can be entered to create new access keys 525 and/or user keys 526.

FIGS. 3 and 4 describe the creation of new access profile 514 and/or new user profile 515. Personal unique information login credentials 516 are used to create a digital signature unique to a user that will be placed on their access card. Message digest function 517 comprises formatting data so that it can be read by control computer 60. Message authentication code 518 is server controlled data that is parsed with personal information. Public key encryption algorithm 519 corresponds with private key 520 to create digital signature 521. Key producer 522 produces new access key 525 (which may provide access for an administrator, enrollment agent, financial agent, or merchant) or user key 526. The access key or user key comprises a digital signature 521, which may be generated via asymmetric encryption, random generation 523, or blowfish encryption 524. Keys could then be physically mailed to a verified user location 527. A key may comprise limited data to necessitate interactive authentication with control computer 60, thereby minimizing damages by theft and/or copying of the key itself.

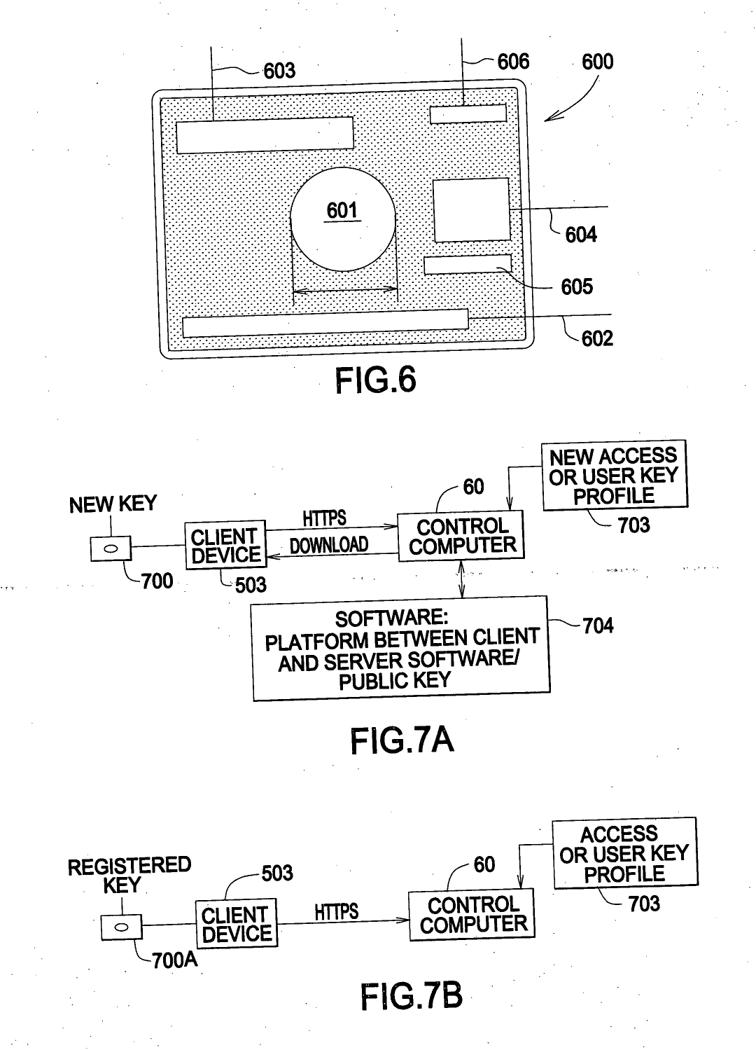

FIG. 6 is an illustration of an access or user card 600. By way of example and not of limitation, access card 600 may be a CDROM read-only card; other types of media such as DVD, ROM, Blue Ray, or any other equivalents thereof or medium that can contain memory may be utilized.

Access card 600 may be in any shape that is currently known in the art or the equivalent thereto. For example, user card 600 may be rectangular in shape and may be approximately the size of a common credit card. Access card 600 may comprise a medium such as a compact disc in the common shape of an annulus, having a circular outer perimeter and a circular inner perimeter that is engaged by the disc drive. System 40 is not limited to access card 600 described here, but can also include future technologies that would provide various other mediums.

In the embodiment shown, access card 600 may contain CDROM capture hole 601, externally printed user name 602, externally printed issuing entity logo 603, and an externally printed unique ID number marker 604 that can be used to distinguish between duplicate user names. ID marker 604 can be a number, bar code, hologram, or any other unique data identifier.

The memory 605 of access card 600 may internally comprise a unique digital signature and a digital copy suppression scratch 606 to prevent copying of any data internally stored thereon. The access card 606 or key may be used either as a user key, and/or an access key. Access card 606 may comprise limited data to necessitate interactive authentication with control computer 60, thereby minimizing damages by theft and/or copying of access card 606 itself.

FIG. 7A is a schematic diagram of the authentication of new key 700 when first used in an on-line transaction. Once a user has received new key 700, which may be resident in an access card that may be direct mailed to a registered and authorized mailing address, new key 700 may be used to access control computer 60 via client device 503. New key 700 can be an enrollment agent access key, a financial agent access key, a merchant access key, or a user key. New key 700 may represent either a new access key 525 or a new user key 526 as shown in FIG. 5.

An access card, such as shown in FIG. 6, having key 700 may interface with client device 503 whereupon a user 100 logs onto an https website associated with control computer 60, thereby connecting to control computer 60. Control computer 60 compares the new access or user key digital signature to an appropriate profile 703. After user 100 is verified, control computer 60 may request any verification data required by profile 703. For example, biometric or email identification may be used for authentication purposes.

After user 100 has been authenticated, control computer 60 sends software 704, which may comprise a public key, down to client device 503. Installed software, which acts as a platform between control computer 60 and client device 503, runs on client device 503 to create a hardware identification signature key. The hardware identification signature key generated by installed software is derived from information unique to client device 503. For example, the installed software may determine the hardware identification signature key from the media access control (MAC) address, CPU speed, installed memory, and/or other unique static information of client device 503.

The hardware identification signature key is sent to control computer 60 and is storable in user profile 703. Installed software creates a new hardware identification signature each time user 100 logs into client device 503. Subsequent logins cause a currently created hardware identification signature to be sent to control computer 60 for comparison to the stored hardware identification signature residing within profile 703.

Any mismatches may operate to cause a failure in the verification process. An administrative device is a client device 503 that user 100 uses when first using a new key 700 in an on-line transaction. While in other embodiments an administrative device need not be restricted to client device 503 used to a initialize a new key 700, here, the administrator device is the only client device 503 that user 100 may use to change profile settings. A unique client device 503 hardware identification signature, which is created when user 100 first uses new key 700 in an on-line transaction, is used to designate client device 503 as the administrative device. This unique hardware identification signature is used to insure proper client device 503 access. For example, if someone were to image a client device's 503 hard drive with a proper digital signature, client device 503 generates a match with the local hardware prior to transmission, and denies access if no local match is found prior to sending the signature to control computer 60. However, if a local match is found, the signature is transmitted to computer 60 whereupon computer 60 matches the received signature against the user profile signature for verification purposes. The user profile signature is a unique digital signature that may be set so as to be decryptable only on control computer 60. Thus, in this embodiment only the client device 503 used to initialize the first login may be used on subsequent logins. Here, if the administrator device is lost, stolen, or damaged, user 100 or a merchant would have to visit the enrollment or financial institution to have the hardware ID reset on the profile. Additional devices may be added to access or user profile 703.

FIG. 7B is a schematic diagram of an on-line key access to control computer 60 subsequent to initial login. User 100 places a registered key 700A, residing within an access card, such as that shown in FIG. 6, into client device 503, to log into control computer 60 website via https. The hardware and digital signals sent by client device 503 are compared with those stored in profile 703 for verification, and other data desired for final authorization. After user 100 is verified and authorized, user 100 may receive read/write access to user profile 703. Client device 503 operates as an administrative device for key 700A, whereupon user 100 can review and make certain changes to profile 703. For example, user 100 may add, delete, or change parameters such as address, shipping address, third party username, password, privacy settings for a third party registration server, attached debit features, phone number, and security transaction triggering settings dependent on a transaction amount. Though not limited in other circumstances, user 100 may conduct financial transactions, restrict transaction types, and/or restrict a transaction amount.

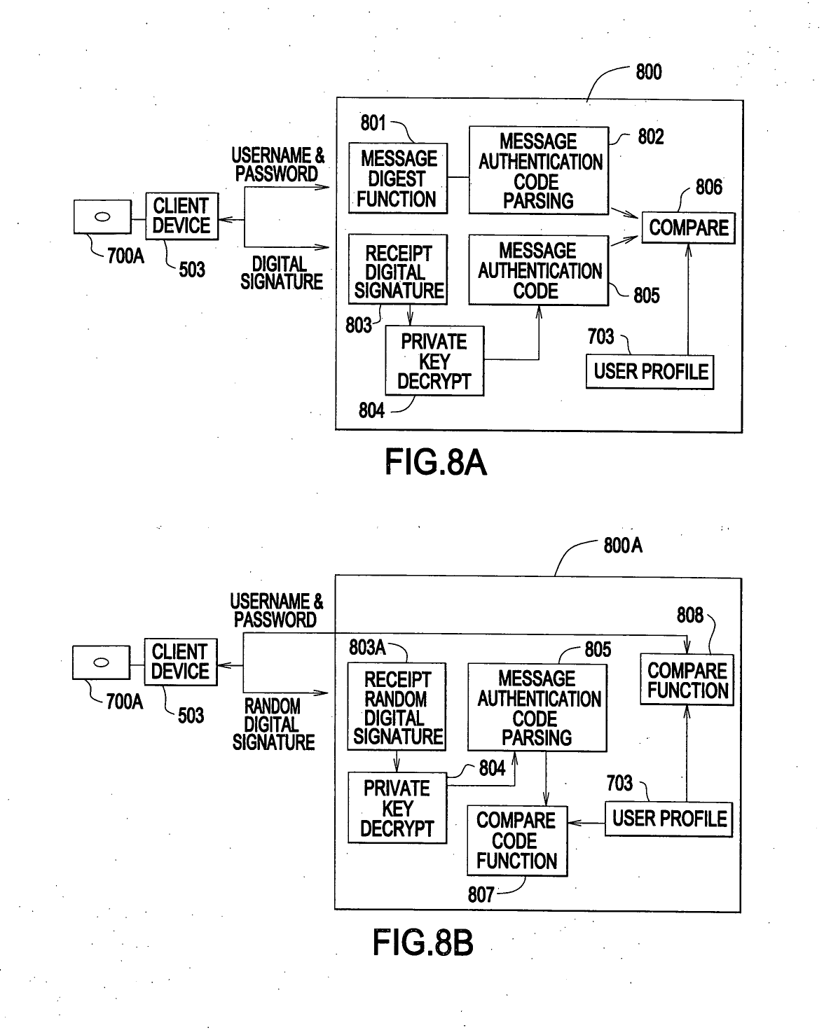

FIG. 8A is a schematic diagram of access key authentication using a digital signature linked to a user name. Registered access key 700A, which may reside in access card 600, is entered into client device 503. Client device 503 accesses control computer 60 via https or a real world transaction. A real world transaction is a transaction where the user is physically present at the merchant's, financial institution's, or enrollment agent's client device 503. Client device 503 can be a user computer, merchant computer, or other device. The username and password, along with digital signature 521 (residing within access card 600) are interpreted by control computer key authentication software 800, which resides within control computer 60, and comprises:

Message digest function 801 to receive username and password;

Message authentication code function 802 to parse and format the username and password of a received message;

Code function 803 to receive the digital signature;

Private key decryption code function 804 to decrypt the digital signature;

Message authentication code function 805 to format the digital signature; and

Compare code function 806 to compare both the digital signature and the username password to user profile 703 data.

After software 800 performs code comparison function 806, key 700A is either authenticated, or a message is sent to client device 503 designating authentication failure.

If authentication fails, client device 503 may for example, send a signal to authorities or to an operator to call authorities or to confiscate the card.

FIG. 8B is a schematic diagram of access key authentication using a random digital signature, an alternate embodiment for access key authentication. In this embodiment, the username and password, along with a random generated digital signature residing within access card 600 are interpreted by control computer key authentication software 800A. Because the digital signature is random, it is not necessarily directly tied to the user name or password. Key authentication software 800A, which resides within control computer 60, comprises:

Comparator function 808 to compare the username and password to that stored in user profile 703;

Code function 803A to receive the random digital signature;

Private key decryption code function 804 to decrypt the random digital signature;

Message authentication code function 805 to format the digital signature; and

Compare code function 807 to compare the random digital signature to the user profile 703 data.

After software 800A performs comparison function 808, key 700A is either authenticated, or a message is sent to client device 503 to take a designated action if authentication fails.

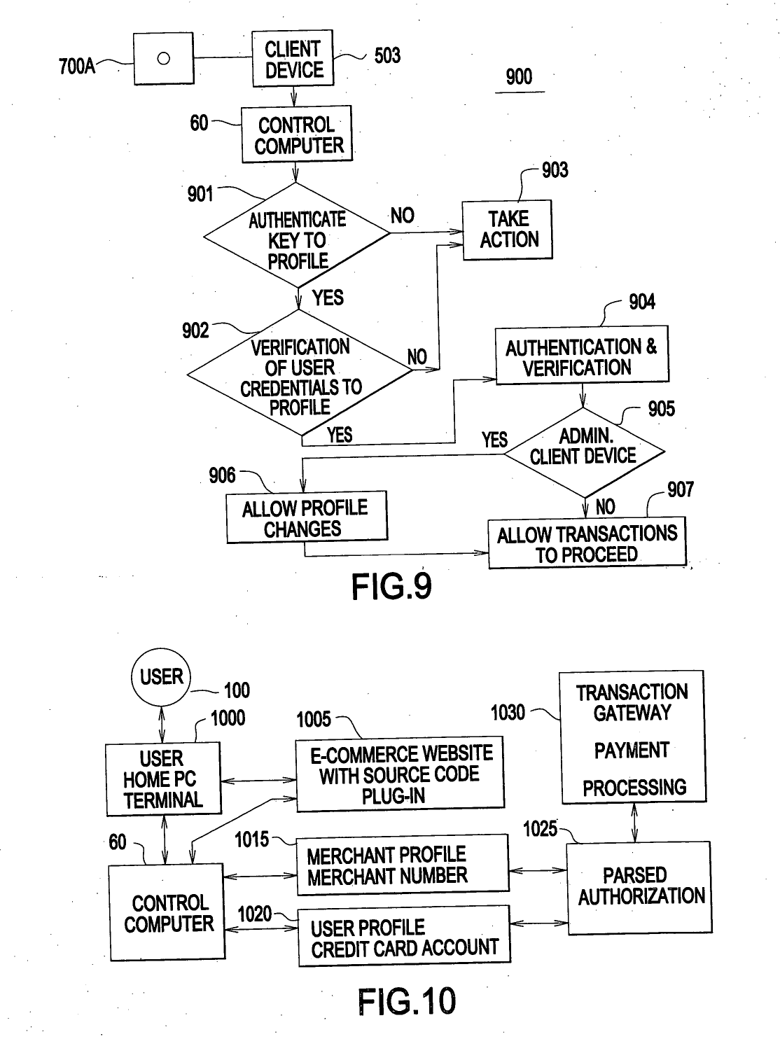

FIG. 9 is a schematic diagram of a transaction approval process 900. Client device 503 can be either a user client device, or an administrative device. The transaction approval process comprises the following steps:

User 100 enters registered access key 700A which may reside within an access card into client device 503;

Client device 503 accesses control computer 60;

Decision 901 determines if key 700A can be authenticated to a profile;

If the result of decision 901 is negative, the process continues to operation 903 where action is taken;

If the result of decision 901 is positive, the process continues to decision 902, which determines if the user credentials can be verified from the profile;

If the result of decision 902 is negative, the process continues to operation 903 where action is taken;

If the result of decision 902 is positive, operation continues to authentication and verification process 904;

Decision 905 tests if client device 503 is an administrator device; and

If the result of decision 905 is positive, the process proceeds to operation 906 allowing profile changes to take place before proceeding to operation 907, otherwise, the process proceeds to operation 907 where the transaction proceeds.

In this embodiment, the operation allowing a transaction to proceed 907 applies to limited on-line transactions. By way of example and not of limitation, such transactions may include payments to another user account, payments to a credit card, transfers of funds within user accounts, and the like. Real time and merchant type transactions at merchant locations will be discussed below.

Although operation 907 allows a transaction to proceed after authentication and verification, operation 907 does not necessarily imply that a transaction will be successful. For example, a bank account may be short of what is required to complete a debit transaction, etcetera.

System 40 can provide for an email alert system to alert user 100 of the occurrence of one or more selected transaction types. For example, user 100 can select to receive automated email alerts of refunds, credits, payments, monies received, etc.

FIG. 10 is a schematic diagram of an on-line transaction with an e-commerce merchant. The transaction comprises of the following steps:

User 100 engages in on-line shopping using client user computer 1000. User computer 1000 may be a user registered computer, the same administrative device which is the initial client device that user 100 registered with and the hardware identification signature is stored within (see FIG. 7A), or a different client device altogether.

User 100 goes to e-commerce website 1005 for an e-commerce merchant. The e-commerce merchant is a registered control computer merchant. User 100 shops at the e-commerce website 1005, i.e. selects articles for purchase, adds them to a shopping cart, and views the total price and/or selects payment options from the e-commerce website GUI. User 100 enters his name, address, and other information as required by the merchant whereupon a payment option is presented to user 100. If user 100 selects to pay with system 40, as listed e-commerce website 1005 will connect user 100 to control computer 60.

User 100 and merchant are now connected to control computer 60. E-commerce website 1005 will operate to send information such as shipping address, transaction number, and merchant ID number to control computer 60. If desired, shipping address, transaction number, and merchant ID number may be encrypted before being sent to control computer 60. For example, data transmission may be conducted using a secure socket layer, such as with 128 bit encryption.

In this embodiment, control computer 60 will match the merchant ID to an appropriate merchant profile 1015. Merchant profile 1015 can be structured such that authentication procedures depend on the characteristics of the transaction. For example, merchant profile 1015 can be structured to trigger at a predetermined transaction amount. If the predetermined transaction amount, or trigger level, is exceeded, then control computer 60 may require user 100 to enter additional verification data, such as biometric data and/or supply an access card. Merchant profile 1015 can also be structured to request acceptable forms of payment. For example, the merchant can elect to accept only particular credit or debit cards. In another example, merchant profile 1015 can be structured to require verification of a user's 100 address. Such verification could be performed by control computer 60 matching an address provided by user 100 to the address stored in user profile 1020.

Control computer 60 authenticates user 100 based on an appropriate level of security, user profile 1020 match, and/or credit card account information. Control computer 60 could also present a GUI at merchant website 1005 for user 100 to select a method of payment. For example, the GUI could present user 100 with active credit cards or debit cards available to user 100 via user profile 1020. User 100 may then select a desired method of payment. By way of example and not of limitation, authentication may include comparison of user information to information stored in user profile 1020, such as address, etc.

In step 1025, the user selected payment method, the merchant data, and the payment amount are parsed to create a payment authorization which may then be sent to an appropriate transaction network via transaction gateway 1030. For example, a transaction network may consist of typical major credit card networks.

User 100 receives a response via merchant e-commerce website 1005 GUI stating whether the transaction is successful. If the transaction is successful, the merchant is funded triggering shipment of goods or services purchased by user 100.

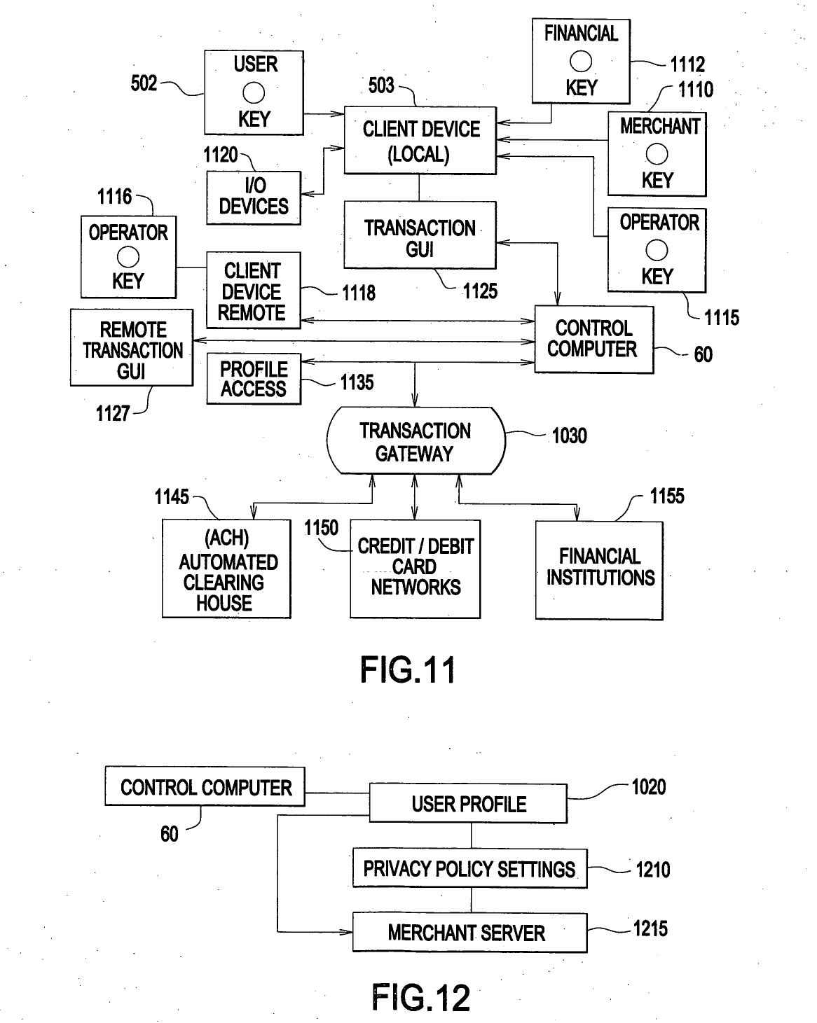

FIG. 11 is a schematic diagram of a real world transaction. A real world transaction is a transaction where the user is physically present at the merchant's, financial institution's, or enrollment agent's client device 503. For purposes of description of this figure and not as a limitation, it will be assumed that payment will require a control computer to authenticate a user. In describing FIG. 11, various real world scenarios will be discussed.

In a real world transaction, client device 503 may be a registered device on either a merchant's profile, or a financial institution's profile. Client device 503 is linked to control computer 60. Client device 503 is made active by a merchant or a financial institution conducting a successful login via respective access keys, 1110, or 1112. Although only one client device 503 is shown, a merchant or financial agent could activate more than one client device 503 on a network.

Time and/or date restrictions may be associated with a client device 503 in any appropriate profile (e.g. merchant profile, financial profile, and/or enrollment profile) such that client device 503 accesses control computer 60 at specified times. For example, a world wide entity may desire to set time restrictions so that its client devices 503 are able to access control computer 60 at times dependent on a physical location of client device 503 in a specific geographic area or time zone. As another example, individual client devices 503 at a given geographic location can be set to different date/time restrictions. Various combinations are possible and configuration is dependent upon the preference of a merchant, financial institution, and/or enrollment agent.

In FIG. 11, each client device 503 on a network can be configured to operate in one of the following modes: automatic, remote operator, or operator present. Remote client devices 503 can be automatically set in a predetermined mode via a merchant profile or a financial profile. The automatic mode, via an appropriate profile, may determine and set client device 503 function. For example, client device 503 can be set up to act as a payment transaction terminal, to act as a remote entry access terminal, or to provide other unique functions, based on predetermined profile security settings.

Once client devices 503 are authenticated and configured, they are authorized to communicate with control computer 60. In the sample scenarios presented below, it is assumed that transaction users are registered members of system 40.

Scenario A involves a financial transaction for goods or services without operator presence. Three possible types of transactions are described:

(1) Procurement of goods or services via a KIOSK—user 100 (customer) physically enters a merchant site, shops, places items in a cart, goes to a KIOSK, and self scans in selected items for procurement. Here, the KIOSK is represented by I/O devices 1120. Transaction GUI 1125 requests user 100 to enter an access card. User 100 enters an access card having user key 502, a user signature, a user name, and a password. Control computer 60 compares the data entered locally against that stored in a user profile for verification purposes. Based on a merchant profile (which may include trigger settings), a user profile, and/or security settings, additional inputs (e.g. biometric, phone number, etc.) may be required of user 100. After the requested user verification data is received, user authentication can complete. Here, user profiles and merchant profiles are represented by profile access 1135. Payment options available are presented to user 100 via the transaction GUI 1125. Payments options can originate from the user profile and can be filtered against payment options acceptable to the merchant, which are contained in the merchant profile. User 100 selects and enters a desirable acceptable payment option. For example, the user selected payment option may be a major credit card. During this process, transaction GUI 1125 will display a transaction status. Control computer 60 parses selected payment information (stored in the user profile) along with merchant data and transaction information to transaction gateway 1030. Transaction gateway 1030 (prior art) processes a transaction with the assistance of an appropriate external network. For example, transaction gateway 1030 may process the transaction by interfacing with a debit/credit card network 1150. Alternatively, a payment option could consist of using a credit card that is affiliated with and authenticated by system 40. In this case, control computer 60 could contact the appropriate financial institution 1155 through transaction gateway 1030. Financial institution 1155 could take appropriate actions to process the transaction, which by way of example and not of limitation, may include determining a user's credit limit, verifying fund availability, and/or debiting a user's account. Control computer 60 transfers funds received from financial institution 1155 to the merchant's account via transaction gateway 1030 and ACH 1145. The transaction GUI 1125 shows the transaction as approved and completed.

(2) A secure entry authorization—this scenario is a subset of the above scenario to the point where user verification inputs are received but user authorization has not completed. The merchant sets up client device 503 so that transaction GUI 1125 is an access GUI. As another example of verification, the merchant profile could contain an email restriction list, wherein control computer 60 would compare an email address in the user profile to the email address restriction list stored in the merchant profile. Here, profiles are represented by profile access 1135. After the requested user verification data is received, user authentication can complete. Control computer 60 sends a command to any locked device signaling it to open so the transaction is completed. The locking device in this scenario is represented by I/O device 1120.

(3) ATM transaction via a KIOSK—a pre-requirement is that a financial agent registers the ATM KIOSK with its hardware identification signature as a client device 503 as previously discussed. The financial agent must also activate the ATM KIOSK using financial institution access key 1112. User 100 (customer) goes to the ATM KIOSK. Each KIOSK is represented by a unique name identifier within the control computer's internal name server. Here, the KIOSK is represented by I/O device 1120. Transaction GUI 1125 requests user 100 to enter an access card having a user key 502. User 100 enters an access card, and user data comprising a user signature, a user name, and a password. Control computer 60 compares the data entered locally for verification against that stored in the user profile. Based on a financial institution profile, and/or the user profile security settings, additional inputs (e.g. biometric and phone number) may be required of user 100. After the requested verification data is received, user authentication can complete. Here, user profiles and financial institution profiles are represented by profile access 1135. Withdrawal options are presented to user 100 via transaction GUI 1125. Withdrawal options can originate from the user profile and can be filtered against options acceptable to the financial institution contained within the financial institution's profile. If desired, the financial institution may limit the maximum daily withdrawal amount. User 100 then selects and enters a desired withdrawal option. For example, the withdrawal option could be a major credit card cash advance. During the withdrawal process, transaction GUI 1125 will display a transaction status. Control computer 60 parses selected transaction information (stored in the user profile) along with the financial institution routing number information and transaction information to transaction gateway 1030. Transaction gateway 1030 processes a transaction as appropriate. For example, transaction gateway 1030 may process a transaction with the assistance of debit/credit card network 1150. Alternatively, a transaction could be processed using a credit card affiliated with the system network. In this case, control computer 60 would contact financial institution 1155 through transaction gateway 1030. Financial institution 1155 processes the transaction as appropriate, which may include actions comprising determining a user's credit limit, verifying fund availability, and/or debiting a user's account. The control computer creates an ACH transfer 1145 to an appropriate financial institution through transaction gateway 1030.

Transaction GUI 1125 indicates that the transaction is approved and completed. Control computer 60 accesses client device 503 registered to the financial profile. Control computer 60 sends appropriate commands to client device 503 to dispense an amount of cash designated by user 100.

Scenario B involves goods or services transactions with an operator presence (local or remote):

(1) Procurement of goods or services at a KIOSK—this is the same scenario as presented above in Scenario A-1, except that a merchant operator is present at transaction GUI 1125. After the requested user verification data is entered, a merchant operator enters a merchant operator card, having merchant operator key 1115, while observing the transaction status via transaction GUI 1125. Upon authentication, a physically present merchant operator has the ability to halt the transaction. For example, the merchant may halt the transaction because a user is recognized by the operator, or a user is recognized by a merchant or financial institution watch list separate from control system profiles 1135. If a merchant operator is remote, the merchant operator could have a separate remote client device 1118 to which the merchant operator could login via remote operator access key 1116. A remote merchant operator could have the ability to monitor the remote transaction GUI 1127 and decide to halt the transaction by interfacing with control computer 60. By way of example and not of limitation, remote transaction GUI 1127 may only present limited transaction details to a remote merchant operator.

(2) Secure entry authorization—this scenario is the same as presented above in scenario A-2 to the point where user authentication is complete. Operator intervention is the same as described above in Scenario B-1 for remote or local operators. Once a user is authorized such that no operator intervention is needed, control computer 60 sends a transaction command to provide automated access. Alternatively, the operator may send a command or take physical action to allow entry.

System 40 can provide for an email alert system to alert user 100 of the occurrence of selected types of transactions. For example, user 100 can elect to receive automated email alerts of the occurrence of refunds, credits, payments, and monies received.

FIG. 12 is a schematic diagram of an on-line remote user registration and authentication process for future user logins to a merchant server. The process enables merchant server 1215 to register a user 100 and perform merchant authentication.

User 100 may set in the user's profile the limits on what security information can be passed from control computer 60 to other servers. For example, user 100 may not want social security number information to be sent to a foreign server.

The system embodiment can be configured so that user 100 conducts the login process on merchant server 1215 or so that user 100 is directed by merchant server 1215 to control computer 60 to conduct the login process. With the first option, when user 100 tries to register via merchant server 1215, merchant server 1215 contacts control computer 60 to pass registration information. Information is passed from control computer 60 to merchant server 1215 in accordance with user privacy policy settings 1210 contained in user profile 1020. If user 100 is directed by merchant server 1215 to control computer 60 to login, control computer 60 conducts the login process. An email alert system may be provided to alert user 100 of completed registrations.

Once user 100 is registered, a remote merchant has the ability to authenticate user 100 on-line for future logins to merchant server 1215. This allows merchant servers 1215, such as on line traders or auctions, to register and authenticate a user. Additionally, the process described in FIG. 12 allows any service that gathers personal information for registration or login to their server 1215 to authenticate this information.

The process of FIG. 12 can also be used to authenticate a user on any computer network. For example, the process of FIG. 12 may control access to computer networks comprising such functions as email services, instant messaging, on-line voting, on-line gaming, and auction services. The process allows providers of such networks to verify user identity prior to allowing users to access the network. This is a security feature that can, for example, eliminate perpetrators from disclosing false information to message services and their users. For example, a messaging service network may require a user to provide information such as user age, user address, user geographic location or zip code, user name, user social security number, and user bank account number information. If desired, transactions, such as email messages, can be sent through control computer 60 to verify the authenticity of a transaction. A secure certificate attachment can be associated with a specific transaction to ensure that that the transaction has been authenticated by control computer 60. Using control computer 60 to authenticate a transaction can prevent fraudulent or unwanted transactions such as email spam.

Future user logins to merchant server 1215 do not necessarily require user 100 to load personal information from control computer 60. For future logins, merchant server 1215 sends user 100 a unique name and password that user 100 could have placed in profile 1020 for that merchant. Control computer 60 could then send login credentials to merchant sever 1215. For example, the login credentials may be structured in a three field format with a field containing personal information from user's profile 1020 to bond a user's name and password to an authorized user. The system is user friendly in that a user need only remember one username and password to access multiple servers 1215. The process of FIG. 12 prevents a breached username and password from being uploaded to another user's profile for access.

For merchant server 1215 to process an on-line transaction, merchant software is installed on merchant server 1215 and a user undergoes authentication. However, transactions from a user device can be structured to only require user access verification. Merchant transactions are initialized via merchant server 1215 whereas user transactions are initialized via user profile 1020.

The process of FIG. 12 can also be used to verify a user's identity. For example, an entity, such as a merchant, can login to control computer 60 from a client device such as a merchant server 1215. The entity can compare information provided by user 100 against information stored in user's profile 1020 residing within control computer 60. In this manner, the entity may verify information provided by user 100. It should be noted that user 100 can restrict the information in user's profile 1020 that user 100 is willing to disclose, where such restrictions are storable as privacy policy settings 1210.

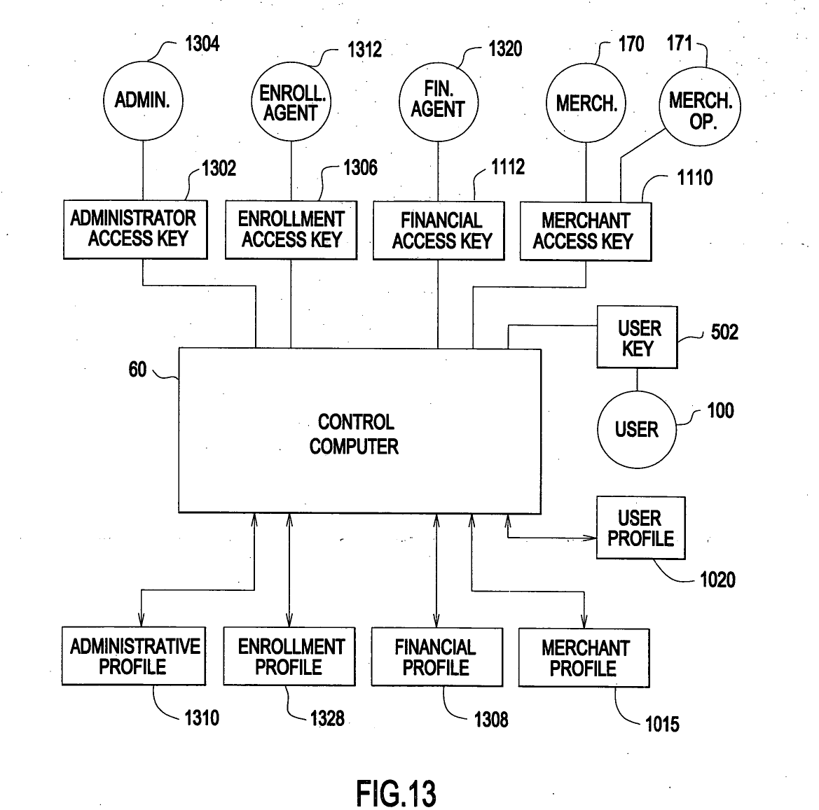

FIG. 13 is an illustration of various keys and profiles that may be enabled by system 40 or some of many configurations that are possible. The keys and profiles included in FIG. 13 are shown by way of example and not limitation. It is to be understood that there can be a single occurrence of each component or a plurality of one or more components as required by the needs of the system applications. Additionally, it is to be understood that there can be a single occurrence of each person or party or a plurality of each person or party.

Administrator access key 1302 operates as a control computer 60 system key, which allows administrator 1304 access to control computer 60. The administrator access key 1302 also allows administrator 1304 to create an enrollment access key 1306 and/or an associated user key 502, and to update information on system 40 as desired.

Enrollment access key 1306 is a key granted by administrator 1304 to enrollment agent 1312 that is given selected and limited access rights to program financial profile 1308 as well as issue financial access keys 1112 and associated user keys 502. Financial access key 1112 is a key granted by enrollment agent 1312 to financial agent 1320 allowing limited access to control computer 60 to create new merchant profiles 1015 and/or user profiles 1020 and merchant access keys 1110 and/or user keys 502.

Merchant access key 1110 is a key granted by financial agent 1320 to merchant 170 which allows merchant 170 and/or merchant operator 171 access to control computer 60 to conduct transactions. User key 502 is a key granted by financial agent 1320 to user 100, which in conjunction with any of the above access keys, allows user 100 access to control computer 60 to conduct a particular transaction. Administrator profile 1310, enrollment profile 1328, financial profile 1308, merchant profile 1015, and user profile 1020 are loggable and storable on control computer 60.

Administrator profile 1310 can comprise data such as administrator 1304 name and an email restriction address. Enrollment profile 1328 can comprise data such as enrollment agent 1312 name, email restriction, hardware ID extracted from enrollment agent's 1312 hardware, and an IP address which is extracted from enrollment agent's 1312 computer or is manually inputted. Financial profile 1308 can comprise data such as a financial agent's 1320 name, address, phone numbers (e.g. phone, fax, mobile, and alternate numbers), a hardware ID extracted from financial agent's 1320 computer, and an IP address which is extracted from financial agent's 1320 computer or is manually inputted. Merchant profile 1015 can comprise data such as a merchant's name, address, location number, banking information, credit card and bank account numbers, hardware identification signature, IP address, etc. as required.

User profile 1020 can comprise data such as the following: user name, user password, date of birth, email address, social security number, banking account(s) information, credit/debit card(s) information gathered from a manual card swipe at a financial institution, government issued I.D. (e.g. drivers license), hardware ID numbers, IP address, user photo, authenticated credit limit, biometric data, authorized mailing address or addresses, and caller identification verification. For example, user 100 can configure the user's profile 1020 such that transactions corresponding to user 100 will only be approved if predetermined minimum and/or maximum authentication procedures are followed.

To allow profile changes, various access rights may be enabled. For example, administrator access key 1302 may be combined with authorized user key 502 and a hardware identification signature on an administrator client device to grant administrator 1304 administrator profile 1310 access. Similarly, enrollment access key 1306 may be combined with authorized user key 502 and a hardware identification signature on an enrollment client device to grant enrollment agent 1312 enrollment profile 1328 access. Financial access key 1112 may be combined with authorized user key 502 and a hardware identification signature on a financial client device to grant financial agent 1320 financial profile 1308 access. Merchant access key 1110 combined with authorized user key 502 and the hardware identification signature on a merchant client device grants merchant 170 merchant profile 1015 access. Likewise, user key 502 may be combined with the hardware identification signature on a user client device 503 to grant user 100 user profile 1020 access.

In the case an access key is lost, stolen, or damaged, user 100 or merchant 170 need only visit the enrollment institution to re-verify identity, whereby enrollment agent 1312 will request information from user 100 or merchant 170 such as user name, password, email address, physical ID cards, credit cards etc. Upon replacement, enrollment agent 1312 could forward a new and unique access card to user 100 or to merchant 170. Upon receipt by user 100 or merchant 170, the card can be activated for real world transactions but must be enrolled on-line again to activate the on-line shopping features. The digital signature for user 100 or merchant 170 is changed so that it is unique to the newly issued card.

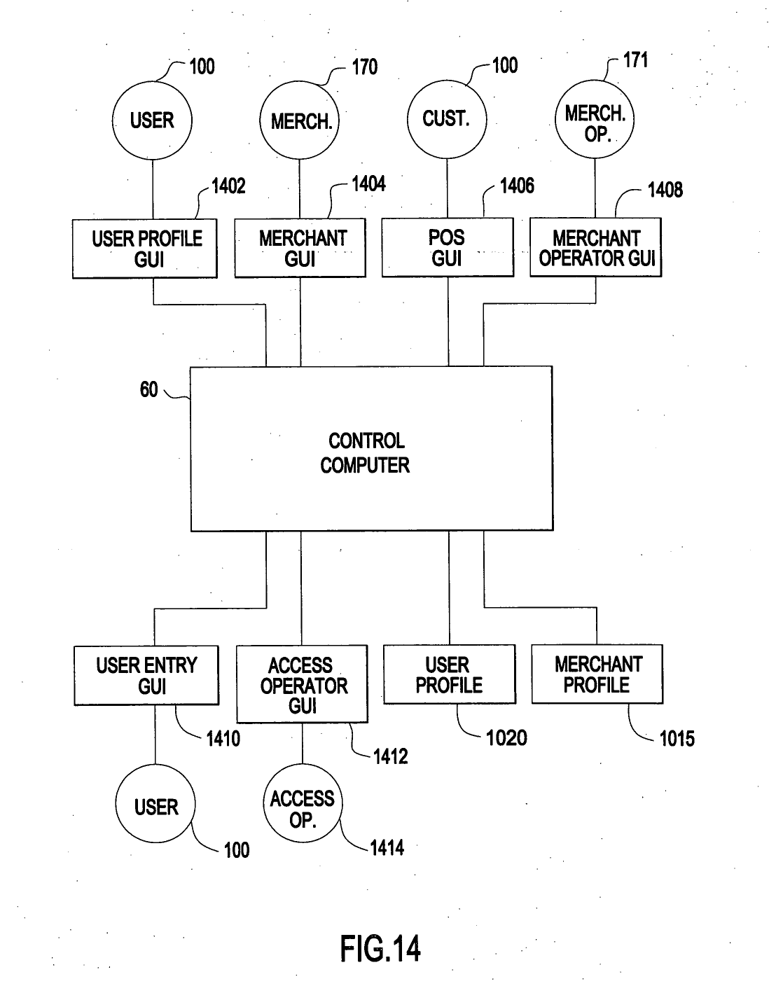

FIG. 14 illustrates examples of graphical user interfaces (GUIs), which may be presented by control computer 60 to individuals comprising users, merchants, merchant operators, financial agents, enrollment agents, and/or administrators. The GUIs illustrated in FIG. 14 are offered by way of example and not of limitation as many configurations are possible. It is to be understood that there can be a single occurrence of each component or a plurality of one or more components as required by the needs of the system applications. Additionally, it is to be understood that there can be a single occurrence of each person or party or a plurality of each person or party.

The GUI presented to an individual is determined by what access the individual is requesting. Each GUI is accessible at different levels that may be designated as either administrative or user access levels. Thus, an appropriate GUI allows control computer 60 to interact with individuals in an appropriate manner. A plurality of GUIs may be presented at a given time.

Anytime during a transaction, an individual may view a window available on a specific GUI pertaining to the transaction and view the details of the transaction. Viewable details can comprise data such as the progress of the transaction during user 100 authentication or the completion of a transaction.

For example, if user 100 wishes to access user's 100 profile 1020, user profile GUI 1402 would be presented to user 100. Similarly, if the individual is an authorized and authenticated merchant 170, merchant GUI 1404, based on merchant profile 1015, would be presented to merchant 170.

In another example, a customer (user 100) making a purchase at a retail store operated by merchant 170, may access a point of sale GUI 1406. If merchant operator 171 is present, merchant operator GUI 1408 can be viewable only by merchant operator 171, while separate customer point of sale GUI 1406 can be made viewable by the customer (user 100).

In the case of building access, other GUIs may be used. User 100 has user entry GUI 1410. If access operator 1414 is present locally or at a remote location, access operator 1414 may be able to disqualify an otherwise successful transaction via access operator GUI 1412. Access operator GUI 1412 may be programmed to send pertinent information directly to access operator 1414 with or without allowing user 100 to view the information. In the case of a remote access operator 1414, control computer 60 could simply send information to two separate client computers, for example, one for user entry GUI 1410 and the other for access operator GUI 1412.

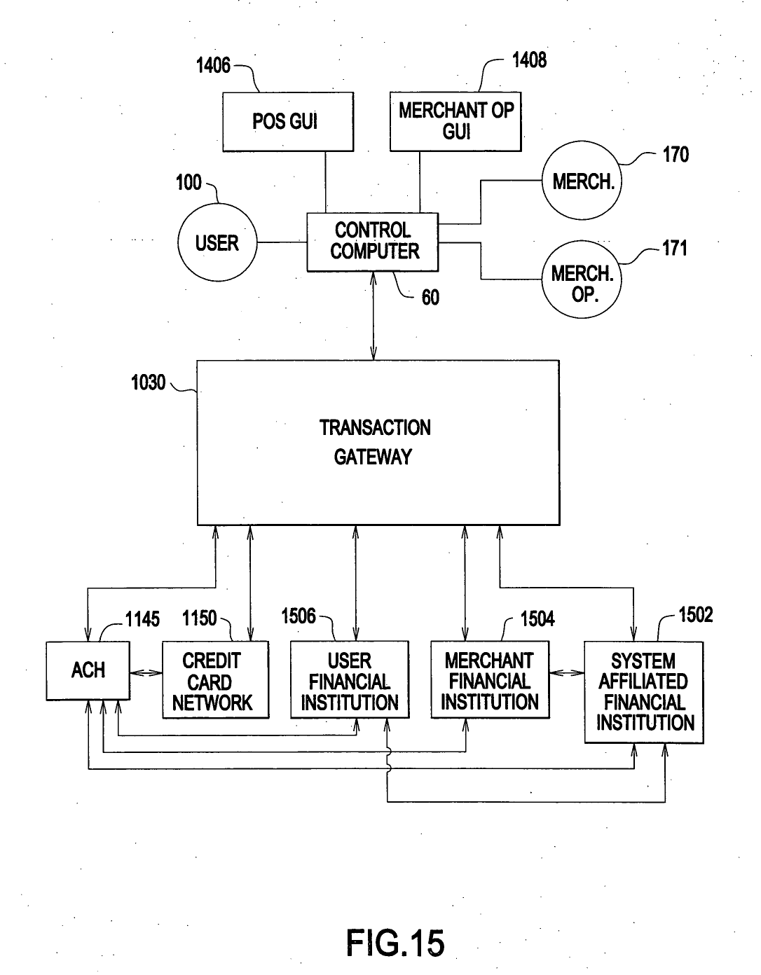

FIG. 15 is a schematic diagram of how financial transactions are processed. Financial transaction processing depends on how user 100 wishes to fund a transaction. The following descriptions of possible transactions apply to a transaction where user 100 wishes to transfer funds to another user and to transactions where user 100 wishes to purchase goods or services from a merchant 170. However, other financial transactions are possible and are not limited to the examples described herein.

If user 100 wishes to conduct a transaction using a credit card issued by a third party, control computer 60 sends transaction data to transaction gateway 1030 which forwards transaction data to an appropriate third party credit card network 1150. Third party credit card network 1150 processes the transaction and returns transaction details to transaction gateway 1030, which forwards the details to control computer 60. Control computer 60 then displays transaction details on an appropriate one or more GUI. For example, the transaction details from third party credit card network 1150 may be displayed on a point of sale GUI 1406 and/or a merchant operator 171 GUI 1408. Third party credit card network 1150 creates an automated clearing house transaction using appropriate user 100 and merchant 170 information received from control computer 60 via transaction gateway 1030. Third party credit card network 1150 sends the automated clearing house transaction to the automated clearing house (ACH) 1145. The ACH debits user's 100 account at third party credit card network 1150 and credits merchant's 170 account at merchant's 170 financial institution 1504.

System 40 can also act as an independent financial system. If user 100 chooses to conduct a transaction with a credit card issued by financial institution 1502 affiliated with the system, control computer 60 creates an automated clearing house transaction and sends it to ACH 1145 via transaction gateway 1030. ACH 1145 debits user's 100 account at system affiliated financial institution 1502 and credits merchant's 170 account at merchant's 170 financial institution 1504.

Alternatively, if user 100 chooses to conduct a debit transaction or an electronic check transaction, control computer 60 contacts user's 100 financial institution 1506 and requests an electronic debit. The user's financial institution 1506 verifies user's 100 account information and that user 100 has sufficient funds to complete the transaction. User's 100 financial institution 1506 returns transaction details to control computer 60 through transaction gateway 1030. Control computer 60 displays transaction details on an appropriate one or more GUI. For example, the transaction details may be displayed on a point of sale GUI 1406 and/or a merchant operator GUI 1408. Upon approval from user's 100 financial institution 1506, control computer 60 creates an automated clearing house transaction using data comprising the transaction amount, user's 100 financial institution 1506 information, and merchant's financial institution 1504 information. Control computer 60 sends the automated clearing house transaction to ACH 1145 through transaction gateway 1030. ACH 1145 debits user's 100 account at user's 100 financial institution 1506 and credits merchant's 170 account at merchant's 170 financial institution 1504. It should be understood that the user's financial institution could comprise system affiliated financial institution 1502 instead of third party user 100 financial institution 1504.

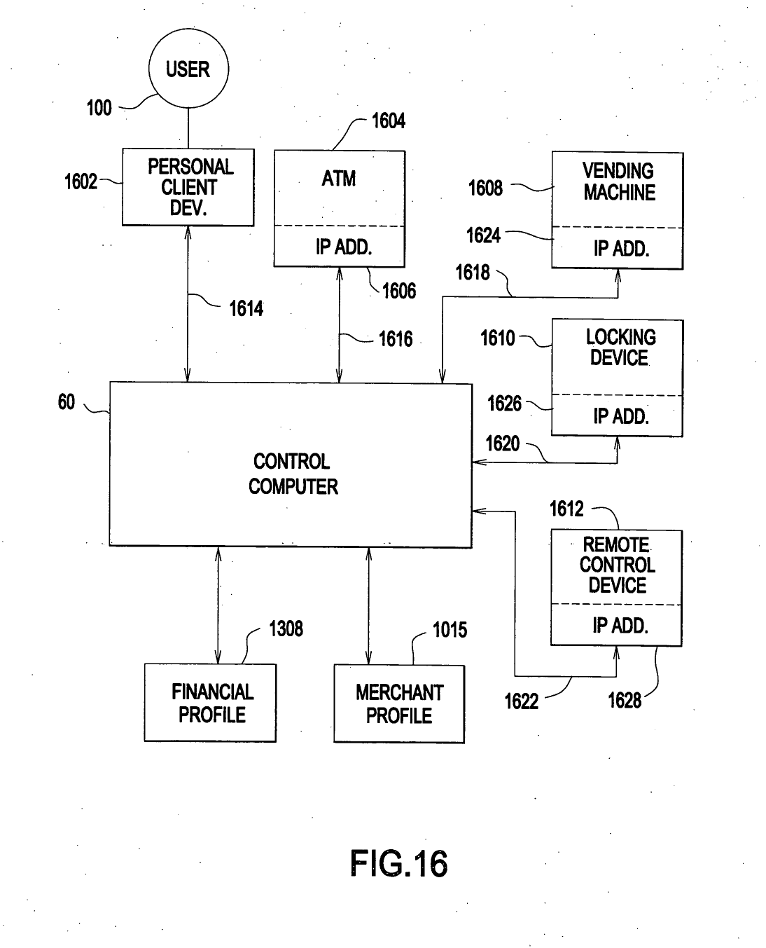

FIG. 16 is a schematic diagram of a personal client device acting as a terminal. Personal client device 1602 communicates with control computer 60 to function as a terminal for another device. For example, personal client device 1602 can comprise a portable personal computer, a personal digital assistant, or a mobile telephone. Personal client device 1602 communicates with control computer 60 over communication link 1614. Communication link 1614 may comprise a mobile telephone network, a wireless computer network, a satellite communication network, a wired communication link, a fiber optic communication link, or any other communication medium or equivalents thereof. The terminal device can be any device that accepts instructions from a control computer to conduct a command. For example, the terminal device can comprise an automated teller machine (ATM) 1604, a vending machine 1608, a locking device 1610, and/or a remote control device 1612. Personal client device 1602 does not necessarily need to be physically close to the device that it is acting as a terminal for.

There is a plurality of applications for the embodiments taught in FIG. 16. The following are examples of some possible applications. It is to be understood that the following applications are offered by way of example and not limitation, and that other applications are possible.

Personal client device 1602 may function as an ATM 1604 terminal. ATM (or cash dispensing device) 1604 is in communication with control computer 60 over communication link 1616 and has IP address (or other network identifier) 1606. As stated above, communication link 1616 may comprise a mobile telephone network, a wireless computer network, a satellite communication network, a wired communication link, a fiber optic communication link, or any other communication medium or equivalent thereof. Control computer 60 authenticates ATM 1604 through use of financial profile 1308 before ATM 1604 processes a transaction.

User 100 logs onto control computer 60 through user's personal client device 1602. Control computer 60 authenticates user 100 before the transaction proceeds. User 100 locates device IP address (or other network identifier) 1606 displayed on ATM 1604. It should be noted that user 100 does not necessarily need to be physically located near ATM 1604. After user 100 enters ATM IP address (or other network identifier) 1606 into personal client device 1602, the device IP address (or other network identifier) 1606 is transferred to control computer 60. Control computer 60 sends to personal client device 1602 an ATM transaction GUI. User 100 enters the necessary information to complete the transaction. For example, user 100 may complete a transaction such as a cash withdrawal, a deposit, or a transfer of cash to a third party via ATM 1604 selected by user 100. Control computer 60 completes the transaction by sending any necessary login credentials and transaction commands to ATM 1604 selected by user 100.

Personal client device 1602 may alternatively function as a terminal for vending machine 1608. Vending machine 1608 is in communication with control computer 60 over communication link 1618 and has IP address (or other network identifier) 1624. Again, communication link 1618 may comprise a mobile telephone network, a wireless computer network, a satellite communication network, a wired communication link, a fiber optic communication link, or any other communication medium of equivalents may be used. Control computer 60 authenticates vending machine 1608 through use of merchant profile 1015 before vending machine 1608 can process a transaction.

User 100 logs onto control computer 60 through user's personal client device 1602. Control computer 60 authenticates user 100 before the transaction proceeds. User 100 locates device IP address (or other network identifier) 1624 displayed on vending machine 1608. It should be noted that user 100 does not necessarily need to be physically located near vending machine 1608. User 100 enters vending machine IP address (or other network identifier) 1624 into personal client device 1602, which transfers device IP address (or other network identifier) 1624 to control computer 60. Control computer 60 sends to personal client device 1602 a vending machine transaction GUI. User 100 selects the products user 100 wishes to purchase from vending machine 1608 and how user 100 wishes to pay for the transaction. Control computer 60 then completes transaction by sending any necessary login credentials, transaction commands, and payment information to vending machine 1608.

Personal client device 1602 can also function as a terminal for locking device 1610. Locking device 1610 is in communication with control computer 60 over communication link 1620 and has IP address (or other network identifier) 1626. Again, communication link 1620 may comprise a mobile telephone network, a wireless computer network, a satellite communication network, a wired communication link, a fiber optic communication link, or any other communication medium of equivalents. Control computer 60 authenticates locking device 1610 through use of merchant profile 1015 before locking device 1610 can be instructed to grant or deny access.

User 100 logs onto control computer 60 through user's personal client device 1602.

Control computer 60 authenticates user 100 before the transaction proceeds. User 100 locates device IP address (or other network identifier) 1626 displayed on locking device 1610. It should be noted that user 100 does not necessarily need to be physically located near locking device 1610. For example, user 100 may wish to grant another access to a remote location. User 100 enters locking device IP address (or other network identifier) 1626 into personal client device 1602 which then transfers device IP address (or other network identifier) 1626 to control computer 60. Control computer 60 sends to personal client device 1602 a locking device GUI. User 100 enters the information necessary to gain access to the area secured by locking device 1610. For example, user 100 may be required to enter verification data. Control computer 60 completes the transaction by sending the necessary login credentials, and transaction commands to locking device 1610.

Personal client device 1602 can also function as a terminal for remote control device 1612. For example, remote control device 1612 may allow user 100 to remotely control the operation of lights and climate control equipment in user's 100 home. Remote control device 1612 is in communication with control computer 60 over communication link 1622 and has IP address (or other network identifier) 1628. Again, communication link 1622 may comprise a mobile telephone network, a wireless computer network, a satellite communication network, a wired communication link, a fiber optic communication link, or any other communication medium of equivalents may be used. Control computer 60 authenticates remote control device 1612 through use of the appropriate profile before control computer 60 can provide commands to remote control device 1612.

User 100 logs onto control computer 60 through user's personal client device 1602. Control computer 60 must authenticate user 100 before the transaction proceeds. User 100 locates device IP address (or other network identifier) 1628 associated with remote control device 1612. It should be noted that user 100 usually will not be physically located near remote control device 1612. User 100 enters remote control device IP address (or other network identifier) 1628 into personal client device 1602, which transfers device IP address (or other network identifier) 1628 to control computer 60. Control computer 60 sends to personal client device 1602 a remote control GUI. User 100 then enters information necessary to remotely control the devices of interest. Control computer 60 completes the transaction by sending the necessary login credentials, and transaction commands to remote control device 1612.

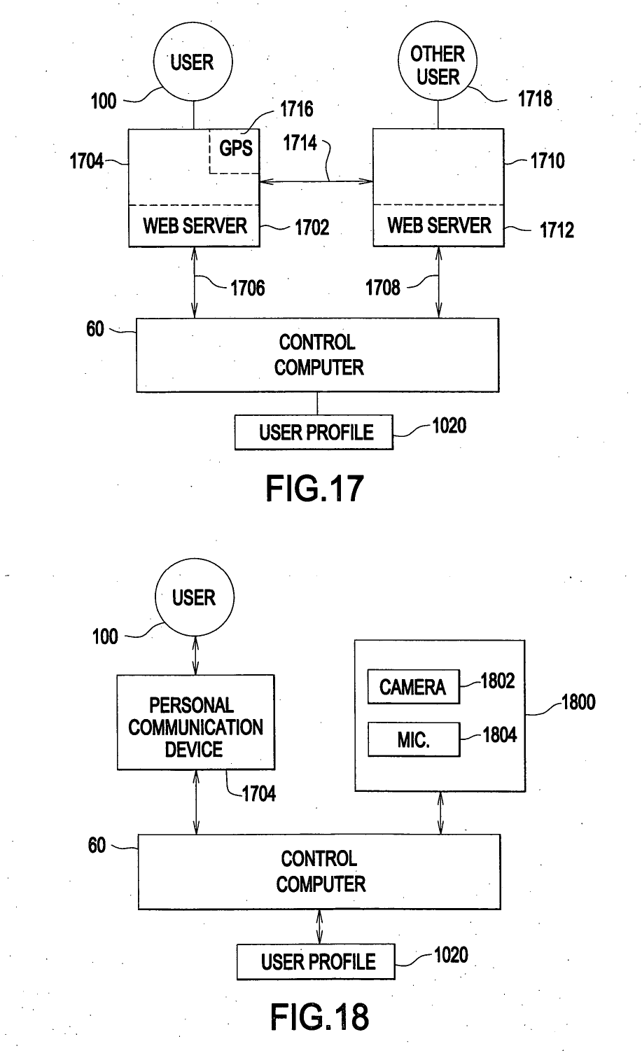

FIG. 17 is a schematic diagram of the operation of a personal communication device containing a web server and its interaction with other devices. A client device comprising a personal communication device 1704 having an internal web server 1702 with the ability to communicate with the control computer 60 is shown. Personal communication device 1704 may comprise devices such as a mobile telephone, a personal digital assistant, and/or a global positioning system. It is to be understood that the illustration of FIG. 17 and the description of FIG. 17 can have a single occurrence of each component or person or a plurality of one or more components or persons as required by the needs of the system applications.

Internal web server 1702 within personal communication device 1704 can communicate with control computer 60 over a communication link 1706. By way of example and not of limitation, an additional client device 1710 with an internal web server 1712 can communicate with control computer 60 over a communication link 1708, and/or with personal communication device 1704 over communication link 1714. For purposes of FIG. 17, communication links 1706, 1708, and/or 1714 may comprise a mobile telephone network, a wireless computer network, a satellite communication network, a wired communication link, a fiber optic communication link, a blue-tooth link, or any other communication medium or equivalents thereof.

Personal communication device 1704 can exchange information with other devices, such as additional client device 1710. The information exchange is controlled by control computer 60. Although the information exchanged between personal communication device 1704 and client device 1710 may be caused to flow through control computer 60 over communication links 1706 and 1708, the information exchanged between personal communication device 1704 and client device 1710 may be caused to flow directly between the devices over communication link 1714. Regardless of how information flows between personal communication device 1704 and device 1710, control computer 60 controls the flow of information.

User 100 can control to what extent, if any, control computer 60 permits the exchange of information from user's 100 personal communication device 1704 with client device 1710. User 100 may specify under what circumstances data is to be exchanged by an appropriate configuration of user's 100 user profile 1020. Similarly user 100 may specify under what circumstances data is to be exchanged by an appropriate configuration of software and/or hardware in user's 100 personal communication device 1704. Alternately, user 100 can determine whether to permit information to be exchanged on a case-by-case basis in response to a request to exchange information. Such request would be sent by control computer 60 on behalf of client device 1710.

There is a plurality of applications for the embodiments taught in FIG. 17. The following are examples of some possible applications. It is to be understood that the following applications are offered by way of example and not of limitation, and that other applications are possible.

One possible application is to control of the exchange of global positioning system (GPS) location coordinates. Personal communication device 1704 can comprise a global positioning system (GPS) 1716, which determines the location coordinates of personal communication device 1704. User 1718 of client device 1710 may wish to know the location of user 100. User 1718 can request this information through control computer 60. Control computer 60 may unilaterally evaluate this request based on user's 100 user profile 1020. Alternately, control computer 60 may ask user 100 of personal communication device 1704 whether user 100 wishes to transmit a location to user 1718. Depending upon how user 100 responds, control computer 60 will either permit and facilitate the transfer of the location information or deny the request. For example, if user 100 permits the transfer of user's 100 location to user 1718, the location of user 100 can be displayed on a screen on user's 1718 personal communication device 1710. Thus, this embodiment allows user 100 of personal communication device 1704 to decide when, if at all, to make the location coordinates of personal communication device 1704 available to a third party. Similarly, the process can operate in reverse permitting user 1718 of client device 1710 to determine when, if at all, to make location coordinates available to user 100.

Parents who wish to monitor the location of their child may utilize a variation of system 40. A child may be represented as user 100, and the child's parents may be represented as user 1718 of client device 1710. Parents 1718 may structure user profile 1020 of child 100 such that personal communication device 1704 of child 100 automatically provides child's 100 GPS location coordinates to parent's client device 1710.

Another possible application for the embodiments taught in FIG. 17 is authentication of personal communication device 1704 and/or its user 100. Control computer 60 can govern the use of personal communication device 1704 and/or the use of network 1706 that personal communication device 1704 can communicate with.

Personal communication device 1704 may be manually authenticated or activated by user 100 accessing profile 1020 and requesting that personal communication device 1704 be activated. Control computer 60 gathers the personal communication device's 1704 hardware identification information and stores it in user's 100 user profile 1020 for future automatic authentication. By way of example and not of limitation, the hardware identification information of the personal communication device 1704 can comprise the device's 1704 MAC address, serial number, and/or hardware configuration information. Control computer 60 then sends a message, which may comprise digital credentials, to personal communication device 1704 to enable activation. As set forth in the discussion of FIG. 2, user 100 generally must be using an administrative or merchant client computer to access a user profile. However, manual authentication or activation could alternatively be used for user 100 to initially register and use the personal communication device 1704.

Control computer 60 can automatically authenticate personal communication device 1704 after an initial registration and authentication. Automatic authentication can be accomplished by control computer 60 comparing personal communication device's 1704 hardware identification as well as the digital credentials stored within personal communication device 1704 to those contained with user's 100 user profile 1020. As state above, the hardware identification information of the personal communication device 1704 can comprise the MAC address, serial number, and/or hardware configuration information. Control computer 60 can upload new digital credential information to personal communication device 1704 on a regular basis in order to increase security.

Control computer 60 may authenticate user 100 of personal communication device 1704. By way of example and not limitation, such authentication may be accomplished by user 100 entering verification data such as a password or biometric information. Control computer 60 compares the verification data to data contained within user's 100 user profile 1020.

The embodiments taught in FIG. 17 can also enable user 100 to deactivate and/or track a lost or stolen personal communication device 1704. In the event personal communication device 1704 is lost or stolen, user 100 can login to user profile 1020 though an administrative or a merchant computer. User 100 can indicate in profile 1020 that personal communication device 1704 has been lost or stolen. Control computer 60 signals a refusal to authenticate personal communication device 1704 and attempts to obtain its GPS coordinates generated from internal GPS 1716 contained within personal communication device 1704.

Another application for the embodiments as taught in FIG. 17 is the operation of a web site. Because personal communication device 1704 contains an internal web server 1702, user 100 can operate a web site from personal communication device 1704.

FIG. 18 is a schematic diagram of the operation of various security features that may be implemented in system 40. Control computer 60 may be configured to provide additional security features during specified transactions. Such transactions may comprise ATM transactions, vending machine transactions, secure access transactions, remote control operations, on-line transactions, and/or real world transactions.

In one example, user's 100 voice is authenticated in order to complete a transaction. User 100 can provide control computer 60 with a voice signature or a voice recording of user 100 stating one or more words. This voice signature can be provided to control computer 60 during or subsequent to user enrollment. User's 100 voice signature is storable by control computer 60 in user's 100 user profile 1020.

When user 100 wishes to conduct a transaction that requires voice authentication, user 100 provides a voice sample by speaking the word or words stored as user's 100 voice signature into a voice capture device. The voice capture device may be a microphone 1804 built into a transaction device 1800. Alternately, user's 100 personal communication device 1704 may comprise the voice capture device. Using user's 100 personal communication device 1704 as the voice capture device can provide additional security because personal communication device 1704 may be independently authenticated by control computer 60. By way of example and not of limitation, personal communication device 1704 may be independently verified through methods such as caller identification phone number verification and/or hardware device information verification.

After user 100 provides a voice sample to control computer 60 either through transaction device 1800 or user's personal communication device 1704, control computer compares the voice sample to user's 100 voice signature stored in user's 100 user profile 1020. If the voice sample matches the stored voice signature, control computer 60 permits the transaction to proceed. Otherwise, control computer 60 does not permit the transaction to proceed.

Another application is to allow authentication in order to complete a transaction by identifying a user's 100 face. User 100 provides control computer 60 a facial signature consisting of a picture of user's 100 face. This facial signature can be provided to control computer 60 during or subsequent to user 100 enrollment. User's 100 facial signature is storable by control computer 60 in user's 100 user profile 1020.

When user 100 wishes to conduct a transaction that requires facial authentication, user 100 provides a facial sample by providing a picture of user's 100 face. A picture of the user's face may be provided by camera 1802 housed in transaction device 1800. It should be noted that existing ATMs generally already contain built-in cameras and thus would be well suited to function as transaction device 1800 in the case of facial authentication. Alternately, a picture of user's 100 face may be taken by a camera contained within user's 100 personal communication device 1704. Using user's 100 personal communication device 1704 to provide a picture of user's 100 face may provide additional security because personal communication device 1704 may be independently authenticated by control computer 60. By way of example and not of limitation, personal communication device 1704 may be independently verified through methods such as caller identification phone number verification and/or hardware device information verification.

Once user 100 provides a picture of user's 100 face to control computer 60 either through transaction device 1800 or user's 100 personal communication device 1704, control computer 60 compares the picture to user's 100 facial signature contained within user's 100 user profile 1020. If the picture matches the facial signature, control computer 60 permits the transaction to proceed. Otherwise, the control computer 60 does not permit the transaction to proceed.

System 40 may also be used to enable user 100 to restrict permissible types of transactions, permissible timing of transactions, permissible amount of monetary transactions, permissible geographic location of transactions, and/or required authentication procedures for transactions that are authorized under user's 100 user profile 1020. User 100 can structure such restrictions in user's 100 user profile 1020 by accessing user profile 1020 through an administrative device.

The following are examples of transaction restrictions user 100 may structure in user's 100 user profile 1020. The following restrictions are offered by way of example and not of limitation. It is to be understood that system 40 permits a plurality of additional restrictions to be implemented.

User 100 may restrict certain types of transactions from being approved from user's 100 user profile 1020. For example, user 100 may prohibit on-line transactions from being approved if user 100 does not typically conduct on-line transactions.

User 100 may restrict transactions to occur on certain days and/or times. For example, user 100 may prohibit ATM transactions from being approved after 10:00 pm if the user normally does not conduct ATM transactions after this time

Similarly, user 100 may limit the monetary value of certain transactions. For example, user 100 may prohibit the approval of ATM transactions over $100 if the user does not normally conduct ATM transactions over this amount.

User 100 may restrict the geographic scope of transactions. For example, if user 100 does not normally travel outside of the United States, user 100 may prohibit ATM transactions from taking place outside the United States.

User 100 may also specify the required authentication procedures for various types of transactions. For example, user 100 may specify in user's 100 user profile 1020 that ATM transactions within a given geographic area need only be authenticated with verification information consisting of user name, user password, and the user's key while ATM transactions occurring outside of the given geographic area must also be authenticated through voice and/or facial authentication.

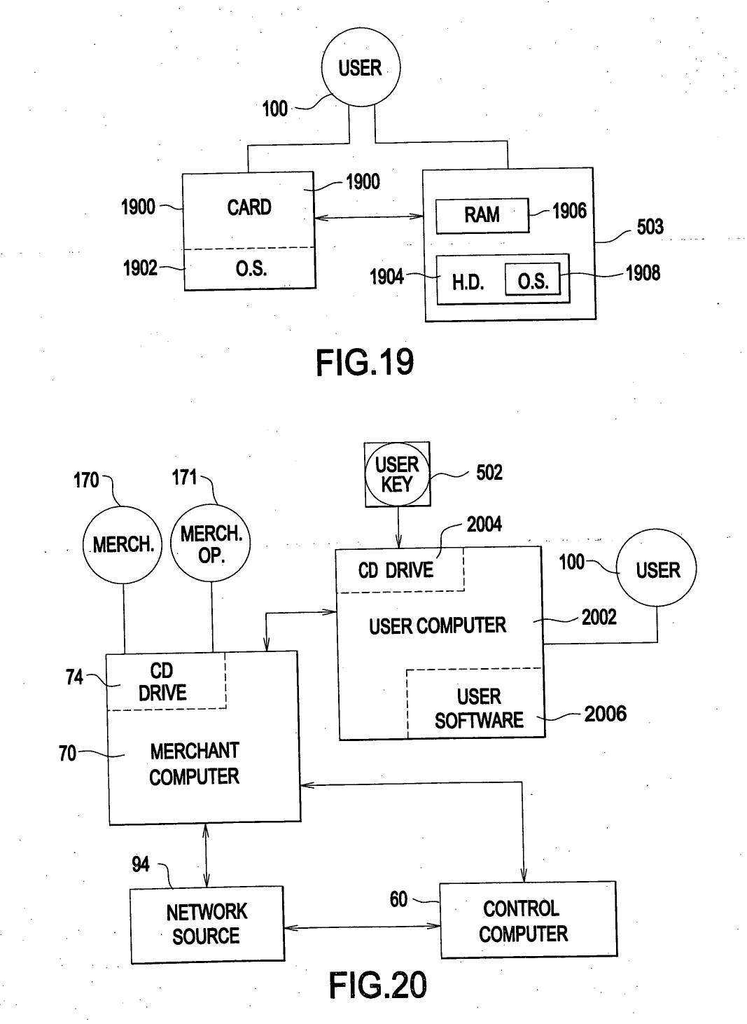

FIG. 19 is a schematic diagram of the operation of an access or user card comprising an operating system. Card 1900 is an alternative embodiment of the card taught in FIG. 6. Card 1900 may comprise limited identity data to necessitate interactive authentication with control computer 60, thereby minimizing damages by theft and/or copying of card 1900 itself.

Card 1900 comprises card 600 illustrated in FIG. 6, in conjunction with a fully functional, stand-alone computer operating system 1902. Upon inserting or connecting card 1900, operating system 1902 is capable of operating a client device. By way of example and not of limitation, operating system 1902 residing within card 1900 may consist of the Linux operating system. Operating system 1902 may also be compatible with a Microsoft Windows compatible client device 503 with at least 64 KB of random access memory 1906. Any equivalent operating system may be used.

Operating system 1902 residing within card 1900 is storable on a read-only medium to prevent modification, e.g. a read only compact disc. Because the medium cannot be written to, operating system 1902 can use client device's 503 random access memory 1906 to temporarily store data. Because the medium cannot be modified, the possibility of operating system 1902 corruption (e.g by viruses, spyware, malware, and/or worms, etc.) is minimized.

Operating system 1902 residing on card 1900 can be used to operate client device 503 without the use of another operating system, such as internal operating system 1908 stored on client device's 503 hard drive 1904. Thus, card 1900 may be used to boot client device 503 without the assistance of client device's 503 hard drive 1904. In this case, user 100 may operate client device 503 with a clean operating system 1902 residing on card 1900 in the event that client device's 503 internal operating system 1908 is corrupted. Similarly, card 1900 may boot client device 503 in the event that an operating system is deficient or is not installed on client device 503. For example, operating system 1902 residing on card 1900 allows user 100 to use client device 503 to access user's 100 files stored on client device 503, send email, and/or operate a web browser without the assistance of client device's 503 internal operating system 1908. Additionally, operating system 1902 residing in card 1900 can enable client device 503 to access control computer 60 without the assistance of client device's 503 internal hard drive 1904.

FIG. 20 is a schematic diagram of an alternative embodiment of the system described in FIGS. 1 and 2. This embodiment comprises the system of FIGS. 1 and 2, and further comprises a user computer 2002 having a compact disc drive 2004 in electronic communication with merchant computer 70. It is to be understood that the system illustrated in FIG. 20 and described in the description of FIG. 20 can have a single occurrence of each component or person or a plurality of one or more components or persons as required by the needs of the system applications.

User 100 and merchant 170 are enrolled as set forth in FIGS. 1 and 2. In the present embodiment, however, user 100 is also issued user software 2006 for download on user computer 2002 as part of the user enrollment process.

When user 100 desires to engage in a transaction with merchant computer 70 using user computer 2002, user 100 of user computer 2002 is in electronic communication with merchant computer 70. For example, user 100 may be viewing a web page from a website maintained on merchant computer 70, and may desire to purchase goods through such website while in electronic communication with merchant computer 70. In such case, user key 502 is connected to and/or inserted in user computer 2002 and read by user computer 2002 using user software 2006. For example, user key 502 may be a compact disc insertable in compact disc drive 2004 of user computer 2002. User 100 also inputs a user name and a user password (which can also be part of the user profile in the user database) into merchant computer 70. User name, user identifier, and user password are combined with the merchant name and merchant identifier (as authorization data). Authorization data is typically encrypted and uploaded to control computer 60. Control computer 60 decrypts the authorization data, and searches the merchant database for a merchant profile that matches the merchant name and merchant identifier, and searches the user database for a user profile that matches the user name, user identifier, and user password, received from merchant computer 70. If any (or a designated portion) of this authorization data does not match, the control computer 60 sends a message to merchant computer 70 to refuse authorization of the transaction.

If all (or a designated portion) of the authorization data matches, control computer 60 sends a request (which is typically encrypted) to merchant computer 70 for certain verification data, or specific user 100 data. Specific user data used for verification data purposes can comprise of a user photo, a user's fingerprints, or a user's driver's license information that was initially designated during user enrollment for transaction authorization. Merchant computer 70 decrypts the request if necessary and prompts user 100, and in some cases a merchant operator 171 (such as a clerk or security guard) operating the merchant computer 70, to input the required verification data into the merchant computer 70. The user 100, and in some cases the merchant operator 171, inputs the required verification data into the merchant computer 70. This verification data is typically encrypted and uploaded to control computer 60. Control computer 60 decrypts the verification data if necessary, and compares the verification data received from merchant computer 70 with the verification data in the person's user profile in the user database. If any of the verification data does not match, control computer 60 may send a message to merchant computer 70 requesting re-input of verification data or refuse authorization of the transaction.

If the verification data matches, control computer 60 sends a message (typically encrypted) to merchant computer 70 to authorize the transaction. For example, merchant computer 70 may be instructed to unlock a door to a restricted area, allow user 100 access to a secure network, or approve a sale. Transaction authorization may be recorded in a transaction log maintained in control computer 60. Depending upon a particular transaction and use of the system, an authorization message may also provide additional information to, and/or request additional data and information from, the merchant computer 70. For example, if the transaction is a purchase of goods or services, control computer 60 may provide a list of credit cards that may be used to complete the purchase (which have been previously inputted as user data by user 100 during the user enrollment process), and prompt user 100 to select a choice of desired credit cards into merchant computer 70. In this case, user 100 may enter a choice of credit card and merchant operator 171 may enter the amount of the purchase into the merchant computer 70. Here merchant computer 70 may encrypt transaction data and upload it to control computer 60. Whereupon, control computer 60 may electronically submit pertinent portions of user data and transaction data to a network 94 or other source for approval of the credit card purchase, as provided by instructions contained in merchant's 170 merchant profile in the merchant database.

If approval for the credit card transaction is received from network 94, control computer 60 may send a message (typically encrypted) to user computer 2002 that the purchase transaction has been approved. Such message may also instruct the merchant computer 70 to take certain action, such as open the compact disc drive 74 in which user key 502 may be located and print a receipt for the transaction. If a denial of authorization for the credit card transaction is received from network 94, control computer 60 may send a message (typically encrypted) to user computer 2002 that the purchase transaction has been denied. Such message may also instruct merchant computer 70 to take certain action, such as to refuse to return user key 502 to user 100. Similarly, such message may also instruct merchant operator 171 to take certain action, such as confiscate user key 502 and contact law enforcement personnel. The purchase transaction (or its denial of approval) may be recorded in the transaction database maintained in control computer 60.

As an alternative, rather than processing the purchase transaction through control computer 60, the authorization message sent to the merchant computer 70 from control computer 60 prompting a choice of credit card may also instruct merchant computer 70 to combine the transaction data received by merchant computer 70 in response to the prompt with other designated user data, merchant data, or both, and contact the network 94 or other source directly. In such cases, the authorization message sent to merchant computer 70 from the control computer 60 may also contain a key necessary to receive approval by means of such network 94 or source.

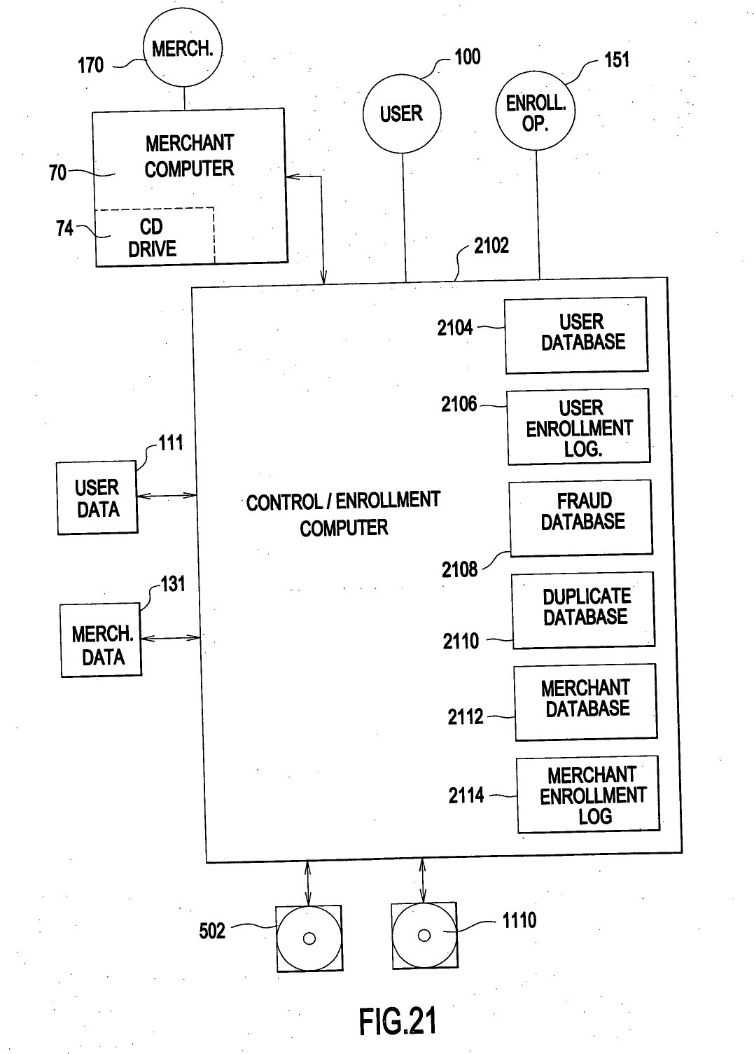

FIG. 21 is a schematic diagram of an alternative embodiment of the system described in FIGS. 1 and 2. This embodiment comprises a combination control/enrollment computer 2102 in electronic communication with a merchant computer 70. In this embodiment, the functions of enrollment computer 50 and control computer 60, as previously described in FIGS. 1 and 2, are combined and performed by control/enrollment computer 2102. It is to be understood that the system illustrated in FIG. 21 and described in the description of FIG. 21 can have a single occurrence of each component or person or a plurality of one or more components or persons as required by the needs of the system applications.

Here uploaded user identity data 111 (including the verification data) is entered into control/enrollment computer 2102, which stores it as a user profile in user database 2104 within control/enrollment computer 2102. The user enrollment may also be recorded in user enrollment log 2106 maintained in control/enrollment computer 2102. Control/enrollment computer 2102 may send a message (which is typically encrypted) to user 100 that the user enrollment process is complete. A unique user name and user identifier, which are also a part of the user profile, are digitally recorded on user key 502. User key 502 is issued to user 100.

In some cases, control/enrollment computer 2102 compares uploaded user identity data 111 with existing user profiles in user database 2104 and fraud profiles in fraud database 2108 maintained in control/enrollment computer 2102 in the same manner as previously described in FIGS. 1 and 2 prior to entering new user identity data 111 into user database 2104. In such cases, if there is already a user profile or duplicate user data in user database 2104, control/enrollment computer 2102 may also enter new uploaded user identity data 111 into duplicate database 2110 maintained within control/enrollment computer 2102. In such cases, if there is already a user profile or duplicate user data in user database 2104, or if new uploaded user identity data 111 matches all or some designated portion of a fraud profile in fraud database 2108, control/enrollment computer 2102 may deny authorization of the user enrollment, instruct an enrollment operator 151 operating control/enrollment computer 2102 to take certain action (such as contact law enforcement), or both. The denial of user enrollment may also be recorded in user enrollment log 2106 maintained in control/enrollment computer 2102.

In this embodiment, merchant identity data 131 is also entered into control/enrollment computer 2102, which stores it as a merchant profile in merchant database 2112 within control/enrollment computer 2102. A unique merchant name and merchant identifier, which are also a part of the merchant profile, are digitally recorded on merchant access key 1110. Merchant access key 1110 is issued to merchant 170, along with merchant software that is necessary to operate the system feature of this embodiment on merchant computer 70, which may have compact disc drive 74 and is also in electronic communication with control/enrollment computer 2102. Control/enrollment computer 2102 may send a message (which is typically encrypted) to merchant 170, to merchant computer 70, or both that the merchant enrollment process is complete. The merchant enrollment may also be recorded in merchant enrollment log 2114 maintained in control/enrollment computer 2102.

In some cases, control control/enrollment 2102 compares merchant identity data 131 with existing merchant profiles in merchant database 2112 and fraud profiles in fraud database 2108 maintained in control/enrollment computer 2102, in the same manner as in the system described in FIGS. 1 and 2, before entering new merchant identity data 131 into merchant database 2112. In such cases, if there is already a merchant profile or duplicate merchant data in merchant database 2112, control/enrollment computer 2102 may also enter new merchant identity data 131 into duplicate database 2110 maintained within control/enrollment computer 2102. In such cases, if there is already a merchant profile or duplicate merchant data in merchant database 2112, or if new merchant identity data 131 matches all or some designated portion of a fraud profile in fraud database 2108, control/enrollment computer 2102 may deny authorization of the merchant enrollment, instruct enrollment operator 151 operating the control/enrollment computer 2102 to take certain action (such as contact law enforcement), or both. The denial of merchant enrollment may also be recorded in merchant enrollment log 2114 maintained in control/enrollment computer 2102.

In FIG. 21, transactions are conducted in substantially the same manner as previously described in FIGS. 1-19, except that control/enrollment computer 2102 performs all of the functions separately performed by control computer 60 and enrollment computer 50 as shown in FIGS. 1 and 2. Merchant computer 70 performs substantially the same functions in substantially the same manner as the merchant computer previously described in FIGS. 1 and 2.

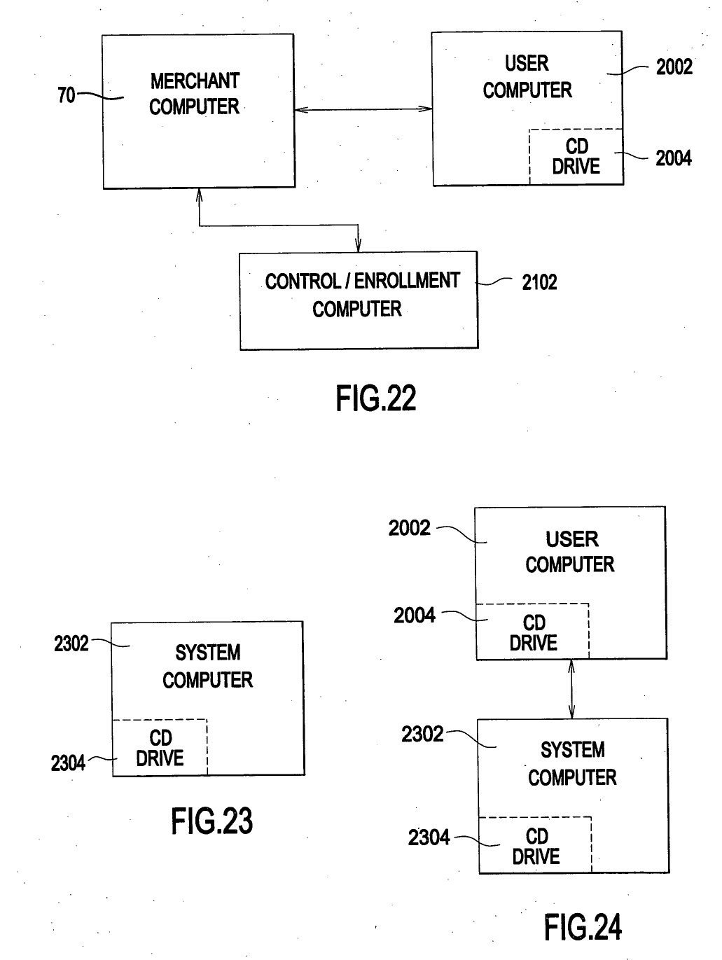

FIG. 22 is a schematic diagram of an alternative embodiment of the system described in FIGS. 1 and 2. This embodiment comprises the embodiment described in FIG. 21, and further comprises user computer 2002 having compact disc drive 2004 in electronic communication with merchant computer 70. It is to be understood that the system illustrated in FIG. 22 and described in the description of FIG. 22 can have a single occurrence of each component or person or a plurality of one or more components or persons as required by the needs of the system applications.

In this embodiment, user computer 2002, merchant computer 70, and control/enrollment computer 2102 operate in the same manner in conducting transactions as the system shown in FIG. 20, except that in this embodiment, the control/enrollment computer 2102 performs the functions of control computer 60 and enrollment computer 50 as shown in FIGS. 1 and 2.

FIG. 23 is a schematic diagram of an alternative embodiment of the system described in FIGS. 1 and 2. This embodiment comprises at least one system computer 2302 having at least one compact disc drive 2304. In this embodiment, the functions of merchant computer 70 and control/enrollment computer 2102 shown in FIG. 21 are combined and performed by system computer 2302. Otherwise, this embodiment operates in the same manner as the embodiment of FIG. 21. It is to be understood that the system illustrated in FIG. 23 and described in the description of FIG. 23 can have a single occurrence of each component or person or a plurality of one or more components or persons as required by the needs of the system applications.

FIG. 24 is a schematic diagram of an alternative embodiment of the system described in FIGS. 1 and 2. This embodiment comprises the embodiment described in FIG. 23 and further comprises user computer 2002 having compact disc drive 2004 in electronic communication with system computer 2302. In this embodiment, user computer 2002 and system computer 2302 operate in the same manner in conducting transactions as the embodiment shown in FIG. 22, except that in this embodiment, system computer 2302 performs the functions performed by merchant computer 70 as well as control/enrollment computer 2102 shown in FIG. 22. It is to be understood that the system illustrated in FIG. 24 and described in the description of FIG. 24 can have a single occurrence of each component or person or a plurality of one or more components or persons as required by the needs of the system applications.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope. Each apparatus embodiment described herein has numerous equivalents.

1. A distributed data processing system (DDPS) functioning to reduce fraud, said DDPS comprising:
an enrollment computer having data entry capabilities to capture user identity data and/or merchant identity data;
a central control computer having access to one or more databases including user data, and/or merchant data, and/or enrollment data, and/or fraud related data, and/or duplicate data, and/or transaction data;
said central control computer further comprising a key creation subsystem and an authentication subsystem;
a merchant computer having data collection and transaction subsystems;
a first link enabling a first two way communication between the central control computer and the enrollment computer;
a second link enabling a second two way communication between the central control computer and the merchant computer;
wherein each user and/or each merchant may enroll in the DDPS via the enrollment computer, obtain a user key or a merchant access key respectively, and each user may engage in said transaction subsystem as authenticated by the authentication subsystem via the merchant computer and the second link;
the central control computer having a higher level of physical and/or electronic security than the merchant computer; and
the merchant computer having a higher level of physical and/or electronic security than the enrollment computer.

2. The DDPS of claim 1 further comprising a hierarchical key creation structure, wherein:
an administrator access key for a central control computer administrator has an exclusive capability to create an enrollment access key for an enrollment agent;
the enrollment access key has an exclusive capability to create a financial access key for a financial agent;
the financial access key has an exclusive capability to create the user key for each user and the merchant access key for each merchant;
the user key and the merchant access key cannot create any other keys; and
wherein any key further comprises a unique identification subsystem.

3. The DDPS of claim 2, wherein identity data for each user, for each merchant, the financial agent, the enrollment agent, and the central control computer administrator is housed in a respective user profile, merchant profile, financial profile, enrollment profile, and central control computer administrator profile.

4. The DDPS of claim 3, wherein the identity data for the central control computer administrator further comprises:
a name;
a physical address;
an email address;
a client hardware identification signature; and
an internet protocol address.

5. The DDPS of claim 2, wherein the key creation subsystem further comprises a key creation process, the process comprising:
the central control computer administrator, and/or enrollment agent, and/or financial agent interfacing an access key and the user key to a chosen device;
an access key authentication subsystem authenticating the access key;
a user key authentication subsystem authenticating the user key;
a party entering identity data into the chosen device;
the key creation subsystem creating a new access profile and/or a new user profile from the identity data;
the key creation subsystem creating personal unique login credentials from the new access profile and/or the new user profile;
the key creation subsystem creating an alphanumeric identification code from the personal unique login credentials; and
wherein a new access key or a new user key comprising the alphanumeric identification code is produced.

6. The DPPS of claim 1, wherein each key further comprises a portable card with a computer readable segment.

7. The DDPS of claim 6, wherein each key comprises a copy protection subsystem.

8. The DDPS of claim 6, wherein each portable card further comprises a compact disc.

9. The DDPS of claim 6, wherein each key further comprises an alphanumeric identification code.

10. The DDPS of claim 1, wherein the user identity data further comprises:
a user name;
a physical mailing address;
a social security number;
a date of birth;
a user photo;
a government issued identification code;
credit/debit card information;
bank account information;
biometric information; and
a system based transaction limit.

11. The DDPS of claim 1 further comprising a user configurable user profile in a central control computer accessible database, wherein the user profile requires the authentication subsystem to follow a predetermined minimum authentication procedure established by the user when authenticating an individual who purports to be the user.

12. The DDPS of claim 11, wherein the user configurable user profile in the central control computer accessible database further comprises the user profile prohibiting the authentication subsystem from authenticating transactions on behalf of the user that are not of a predetermined transaction type, that exceed a predetermined consideration amount, that fall outside a predetermined time frame, and/or occur outside a predetermined geographic scope.

13. The DDPS of claim 11, wherein the user configurable user profile in the central control computer accessible database further comprises instructing the central control computer to notify the user by electronic means when the central control computer processes transactions of a predetermined category on the user's behalf.

14. The DDPS of claim 1 further comprising a user configurable user profile in a central control computer accessible database, wherein the user profile prohibits the authentication subsystem from transferring predetermined categories of user identity data to a third party when verifying the user on behalf of the third party.

15. The DDPS of claim 1 further comprising a merchant configurable merchant profile in a central control computer accessible database, wherein the merchant profile requires the authentication subsystem to follow a predetermined minimum authentication procedure when authenticating a party who wishes to enter into a transaction with the merchant.

16. The DDPS of claim 1, wherein the user identity data for enrollment of the user further comprises an electronically stored user voice segment.

17. The DDPS of claim 1, where the user identity data for enrollment of the user further comprises an electronically stored image of the user's face.

18. The DDPS of claim 1, wherein the transaction subsystem further comprises an exchange of consideration for a product and/or service.

19. The DDPS of claim 1, wherein the transaction subsystem further comprises a lock control subsystem, wherein the user can operate a lock.

20. The DDPS of claim 1, further comprising a facilitation subsystem, wherein the user can exchange consideration with another party.

21. The DDPS of claim 1 further comprising:
a user computer means functioning to access the merchant computer for conducting a user transaction;
a third link enabling a third two way communication between the merchant computer and the user computer; and
wherein the user may engage in the transaction subsystem as authenticated by the authentication subsystem via the user computer, the third link, the merchant computer, and the second link.

22. The DDPS of claim 1 further comprising:
a device having the ability to generate a device profile comprising its hardware and/or software characteristics;
a fourth link enabling a fourth two way communication between the central control computer and the device;
wherein, the authentication subsystem can authenticate the device via the fourth link by comparing the device profile generated by the device to device data housed in the one or more databases comprising device data accessible to the central control computer; and
the central control computer having a higher level of physical and/or electronic security than the device.

23. The DDPS of claim 1 further comprising a new user and/or a new merchant enrollment process, the enrollment process further comprising:
wherein at least a minimum of predetermined categories of user identity data and/or merchant identity data is provided to the DDPS;
wherein the DDPS compares the user identity data or merchant identity data provided by the new user or new merchant respectively to data housed in the one or more databases comprising registered user data, registered merchant data, fraud related data, and duplicate data;
wherein the DDPS either grants or denies enrollment based upon a predetermined policy in response to the above mentioned comparison;
wherein the DDPS writes the user identity data or merchant identity data provided by the new user or new merchant respectively to one or more databases; and
wherein the new user or new merchant is mailed a key comprising information identifying the new user or new merchant if the DDPS grants enrollment.

24. The DDPS of claim 1 further comprising:
a personal communication device capable of acting as a computer terminal;
an external device capable of conducting a transaction;
a fifth link enabling a fifth two way communication between the central control computer and the personal communication device;
a sixth link enabling a sixth two way communication between the central control computer and the external device; and
wherein the user can access the external device as governed by the central control computer via the personal communication device, the fifth link, and the sixth link.

25. The DDPS of claim 24, wherein:
the personal communication device comprises a portable device;
the external device comprises a lock; and
wherein the user can operate the lock via the portable device, the fifth link, the central control computer, and the sixth link.

26. A distributed data processing security system (DDPSS) functioning to provide secured access to a facility, said DDPSS comprising:
an enrollment computer having data entry capabilities to capture user identity data;
a central control computer having access to one or more databases including user data, and/or merchant data, and/or enrollment data, and/or fraud related data, and/or duplicate data, and/or transaction data;
said central control computer further comprising a key creation subsystem and an authentication subsystem;
a secured facility locking means functioning to open/close via a remote signal;
a first link enabling a first two way communication between the central control computer and the enrollment computer;
a second link enabling a second two way communication between the central control computer and the secured facility locking means; and
wherein a new user may enroll in the DDPSS via the enrollment computer, obtain a user key, and a user may create the remote signal as authenticated by the authentication subsystem via the secured facility locking means, the second link, and the central control computer.

27. A method of authenticating a user or a merchant in order to execute a transaction, the method comprising the steps of:
creating a user identity and/or a merchant identity by assigning each a key;
interfacing the key issued to the user or the merchant to an authentication subsystem;
obtaining from the key information identifying the user or merchant;
determining characteristics of the transaction;
determining authentication requirements for the transaction by comparing the user or merchant identity and the characteristics of the transaction to respective user or merchant authentication requirements previously provided by the respective user or merchant housed in one or more databases accessible to the authentication subsystem;
determining required verification data from the authentication requirements, wherein the required verification data further comprises a user or merchant voice segment and a user's or merchant's driver's license;
requesting the user or merchant to provide the authentication subsystem the required verification data;
providing the authentication subsystem the required verification data;
comparing the required verification data provided by the user or merchant to verification data housed in one or more databases accessible to the authentication subsystem which was provided by the user or merchant respectively during an enrollment process; and
granting or denying authentication based upon a predetermined policy in response to results of comparing the required verification data housed in one or more databases accessible to the authentication subsystem which was provided by the user or merchant respectively during the enrollment process.

28. The method of authenticating the user or merchant of claim 27, wherein the user or merchant is authenticated for one or more third parties.

29. The method of claim 28, wherein the user or merchant is authenticated for the one or more third parties without disclosing some or all of the user's or merchant's personal information to the one or more third parties.

30. The method of authenticating the user or merchant of claim 27, wherein the required verification data further comprises a picture of the user's face.

31. A key comprising:
a portable card having a computer readable segment and a unique cardholder identity key thereon;
said computer readable segment further comprising a read-only computer operating system segment capable of operating a computer; and
wherein the key can be used to operate the computer; and
wherein a user can conduct a transaction only via a central control computer's successful interactive authentication of verification data housed in a central control computer accessible database and not housed in the portable card.

32. The key of claim 31, wherein the portable card overrides an operating system installed on the computer.

33. The key of claim 31, wherein the portable card operates a computer not having a functional operating system.

34. A distributed data processing system (DDPS), the DDPS comprising:
a personal communication device comprising the ability to send data to and receive data from an external device;
a central control computer having access to one or more databases housing a user's data;
a first link enabling a first two way communication between the central control computer and the personal communication device;
a second link enabling a second two way communication between the central control computer and the external device;
wherein the central control computer can police an exchange of data between the personal communication device and the external device; and
wherein the user can create a custom policing protocol.

35. The DDPS of claim 34 further comprising:
a location subsystem, wherein the central control computer tracks a lost or stolen personal communication device by accessing location data provided by a global positioning system housed in the lost or stolen personal communication device; and
wherein upon communication between the lost or stolen personal communication device and the central control computer, the lost or stolen personal communication device sends its location data to the central control computer.

36. The DDPS of claim 34, wherein the personal communication device further comprises a host capability for an internet website.

37. A key creation process, the process comprising the steps of:
interfacing an access key and a user key to a chosen device;
authenticating the access key;
authenticating the user key;
entering identity data into the chosen device;
creating a new access profile and/or a new user profile from the identity data;
creating personal unique login credentials from the new access profile and/or the new user profile;
creating an alphanumeric identification code from the personal unique login credentials; and
producing a new access key or a new user key comprising the alphanumeric identification code.

38. The key creation process of claim 37, wherein each key further comprises a portable card with a computer readable segment.

39. The key creation process of claim 38, wherein the computer readable segment further comprises a read-only computer operating system segment capable of operating a computer.

40. A process of authenticating a key when the key is first used in an on-line transaction, the process comprising the steps of:
providing a card having the key, having a computer readable segment, and having an alphanumeric identification code;
interfacing the key to a chosen device;
logging onto a website associated with a central control computer;
obtaining the alphanumeric identification code from the key;
comparing the alphanumeric identification code from the key to a alphanumeric identification code housed in a database accessible to an authentication subsystem;
determining authentication requirements for the key by comparing a key holder's identity to requirements previously provided by the key holder housed in one or more databases accessible to the authentication subsystem;
determining required verification data from the authentication requirements;
requesting the key holder provide the authentication subsystem the required verification data;
providing the authentication subsystem the required verification data;
comparing the required verification data provided by the key holder to verification data housed in one or more databases accessible to the authentication subsystem which was provided by the key holder during an enrollment process;
granting or denying authentication based upon a predetermined policy in response to results of comparing the required verification data to the verification data provided by the key holder during the enrollment process; and
transferring software having the ability to create a hardware identification signature to the chosen device if the authentication subsystem grants authentication.

41. A process of authenticating a key when used in an on-line transaction subsequent to the key's first on-line transaction, the process comprising the steps of:
providing a card having the key, having a computer readable segment, and having an alphanumeric identification code;
interfacing the key to a chosen device;
logging onto a website associated with a central control computer;
generating a hardware signature of the chosen device;
obtaining the alphanumeric identification code from the key and the hardware signature from the chosen device;
comparing the alphanumeric identification code from the key to a alphanumeric identification code housed in a database accessible to an authentication subsystem;
determining authentication requirements for the key by comparing a key holder's identity to requirements previously provided by the key holder housed in one or more databases accessible to the authentication subsystem;
determining required verification data from the authentication requirements;
requesting the key holder provide the authentication subsystem the required verification data;
providing the authentication subsystem the required verification data;
comparing the required verification data provided by the key holder to verification data housed in one or more databases accessible to the authentication subsystem which was provided by the key holder during an enrollment process;
granting or denying authentication based upon a predetermined policy in response to results of comparing the required verification data to the verification data provided by the key holder during the enrollment process;
comparing the hardware signature from the chosen device to a hardware signature of a device used for initial login of the key housed in a database accessible to the authentication subsystem; and
permitting the key holder to modify a profile associated with the key holder if the hardware signature of the chosen device matches the hardware signature of the device used for initial login of the key.

42. A process of authenticating an on-line transaction between a user and a party, the process comprising the steps of:
providing a card having a computer readable segment, wherein the computer readable segment comprises an unique identification code associated with the user;
providing a current communication device identifiable by an electronic signature, wherein the current communication device is pre-registered via its electronic signature with a central control computer;
providing a database accessible by the central control computer comprising one or more pre-registered electronic signatures, wherein each pre-registered electronic signature corresponds to a communication device pre-registered with the central control computer;
connecting the user to the party via the current communication device and a communication link;
interfacing the card to the current communication device;
verifying that the electronic signature of the current communication device matches one of the pre-registered electronic signatures in the database accessible by the central control computer; and
permitting the on-line transaction to proceed if the electronic signature of the current communication device matches one of the pre-registered electronic signatures.

43. The process of claim 42, wherein the user connects to the party via a web site associated with the party.

44. The process of claim 42, wherein the on-line transaction further comprises a financial transaction.

45. The process of claim 44 further comprising requiring the user to activate the card by registering the card with the central control computer via a communication device and the communication link prior to using the card in a transaction.

46. The process of claim 45 further comprising designating the communication device used to register the card with the central control computer as an administrative communication device.

47. The process of claim 46 further comprising transferring a software application from the central control computer to the administrative communication device via the communication link while the user registers the card with the central control computer.

48. The process of claim 47 further comprising generating an electronic signature of the administrative communication device via the software application while the user registers the card with the central control computer.

49. The process of claim 48 further comprising transferring the electronic signature of the administrative communication device to the database accessible by the central control computer via the communication link while the user registers the card with the central control computer.

50. The process of claim 49, wherein the electronic signature further comprises a drive identification code and a network interface identification code.

51. The process of 46 further comprising permitting the user to register an additional communication device with the central control computer solely via the administrative communication device.

52. The process of claim 42 further comprising the steps of:
providing the current communication device verification data;
verifying that the verification data matches pre-determined verification data;
permitting the on-line transaction to proceed if the verification data matches the pre-determined verification data; and
preventing the on-line transaction from proceeding if the verification data does not match the pre-determined verification data.

53. The process of claim 52, wherein the verification data further comprises a password.

54. A process of authenticating an on-line transaction between a user and a party, the process comprising the steps of:
providing a card having a computer readable segment, wherein the computer readable segment comprises an unique identification code associated with the user;
providing a current communication device identifiable by an electronic signature, wherein the current communication device is not pre-registered via its electronic signature with a central control computer;
providing a database accessible by the central control computer comprising one or more pre-registered electronic signatures, wherein each pre-registered electronic signature corresponds to a communication device pre-registered with the central control computer;
connecting the user to the party via the current communication device and a communication link;
interfacing the card to the current communication device;
verifying that the electronic signature of the current communication device matches one of the pre-registered electronic signatures in the database accessible by the central control computer; and
prohibiting the on-line transaction from proceeding because the electronic signature of the current communication device does not match one of the pre-registered electronic signatures.
